(19) United States
(12) Patent Application Publication
(10) Pub. No.: US 2024/0413854 A1
(43) Pub. Date: Dec. 12, 2024

(54) FIRST NETWORK NODE, SECOND NETWORK NODE, WIRELESS DEVICE AND METHODS PERFORMED THEREBY FOR HANDLING DOPPLER SHIFT PRE-COMPENSATION

(71) Applicant: Telefonaktiebolaget LM Ericsson (publ), Stockholm (SE)

(72) Inventors: Roberto Pinto ANTONIOLI, Fortaleza (BR); Iran MESQUITA BRAGA JUNIOR, Fortaleza Ceará (BR); Gabor FODOR, Hässelby (SE); Yuri C.B. SILVA, Fortaleza-CE (BR); André L.F. DE ALMEIDA, Fortaleza (BR); Walter DA CRUZ FREITAS JUNIOR, Fortaleza Ceará (BR)

(21) Appl. No.: 18/689,748

(22) PCT Filed: Sep. 8, 2021
(86) PCT No.: PCT/SE2021/050857

§ 371 Date: Mar. 6, 2024

(51) Int. Cl. H04B 7/01; H04B 17/391; H04L 25/02; H04W 84/00

(52) U.S. Cl. CPC H04B 7/01; H04B 17/3913; H04L 25/0222; H04W 84/005

(57) ABSTRACT

A method, performed by a first network node. The method is for handling Doppler shift pre-compensation. The first network node sends a first indication towards a first wireless device. The first indication indicates a start of a training phase. The first network node obtains, based on the sent first indication, a set of information from the first wireless device. The set of information indicates: i) a Doppler shift experienced by the first wireless device while moving along a pre-defined trajectory to which a static set of radio network nodes provide coverage, and ii) a set of features characterizing how the first wireless device experienced the Doppler shift. The first network node also initiates determining, using machine-learning, and based on the received set of information, a predictive model of Doppler shift pre-compensation. The training phase is of the predictive model.

### TECHNICAL FIELD

The present disclosure relates generally to a first network node and methods performed thereby for handling Doppler shift pre-compensation. The present disclosure also relates generally to a second network node, and methods performed thereby for handling Doppler shift pre-compensation. The present disclosure further relates generally to a wireless device network node, and methods performed thereby for handling Doppler shift pre-compensation.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

### NR

The standardization organization 3rd Generation Partnership Project (3GPP) is currently in the process of specifying a New Radio Interface called New Radio (NR) or 5G-Universal Terrestrial Radio Access (UTRA), as well as a Fifth Generation (5G) Packet Core Network, which may be referred to as Next Generation (NG) Core Network, abbreviated as NG-CN, NGC or 5G CN.

In the current concept, gNB denotes an NR BS.

One of the main goals of NR is to provide more capacity for operators to serve ever increasing traffic demands and variety of applications. Because of this, NR will be able to operate on high frequencies, such as frequencies over 6 GHZ, until 60 or even 100 GHz.

Operation in higher frequencies makes it possible to use smaller antenna elements, which enables antenna arrays with many antenna elements. Such antenna arrays facilitate beamforming, where multiple antenna elements may be used to form narrow beams and thereby compensate for the challenging propagation properties.

### Internet of Things (IoT)

The Internet of Things (IoT) may be understood as an internetworking of communication devices, e.g., physical devices, vehicles, which may also referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure. “Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### High Speed Train (HST) Communication: Two Options

High-speed deployment scenarios have been recently studied to be supported by 5G networks, which are mainly focusing on the continuous coverage along the track of high-speed trains (HSTs). Two important features of this scenario are the provision of consistent user experience and the assurance of critical communication reliability when trains travel with very high mobility, e.g., 400 km/h to 500 km/h. Indeed, performance requirements for the HST scenario may include: experienced data rate of 50 Mb/s in the downlink (DL) and 25 Mb/s in the uplink (UL), area traffic capacity of 15 Gb/s/train in the DL and 7.5 Gb/s/train in the UL, overall user density of 1,000 users/train, speeds up to 500 km/h and coverage along railways. Real-world implementations of HST communications based on millimeter-wave bands are already being tested, which may achieve data rates higher than 1 Gb/s.

To support the passenger users located inside the train carriages, there may be basically two options suggested in the TR 38.913, v. 16.0.0: macro-only layout, where the gNodeB (gNB) may directly serve the users inside the train; and the macro-and-relay layout, in which a train onboard relay, e.g., a customer premises equipment (CPE) mounted at the top of one train carriage, may receive the signals from the gNB and relay them to the passenger users inside the train. The latter layout is the preferred option, being currently studied because of several issues presented by the former option, including severe penetration loss caused by the train carriage and the so-called signaling storm in a group handover situation, that is, when many users try to handover at the same time. In the macro-and-relay layout, the train may be also referred to as user equipment (UE).

### Multiple Transmission and Reception Points to Support High-Speed Trains

The deployment of multiple linear transmission-and-reception points (TRPs) along the railway line is the current deployment option being considered. In this scenario, both single frequency network (SFN) and non-SFN may be supported. The SFN option is being currently studied within 3GPP Rel-17, in which the same signals may be transmitted from different TRPs and may be then combined at the train as if they were coming from different multi-path channels.

FIG. 1 is a schematic diagram illustrating an HST communication deployment scenario where multiple TRPs, particularly TRP #0, TRP #1 and TRP #2, controlled by a gNB, particularly gNB #0, are deployed along the train railway.

### High Doppler Shift Occurrence

Due to the intrinsic characteristics of very high mobility present in HST communications, some technical challenges may arise, such as short channel coherence time, large Doppler frequency shift and/or spread,, and frequent handover.

One of the key challenges currently being investigated in HST-SFN deployment is related to the occurrence of high Doppler shifts, which may occur due to at least one of the following events: high device movement speed and the envisioned deployment at high frequency band. When a UE is travelling in an HST at very high speeds, e.g., 400 km/h or 500 km/h, and passes between two TRPs, the UE may observe a high positive Doppler shift to one of the TRPs, and a high negative Doppler shift to the other TRP. Besides that, the rate of change of the Doppler shift values may significantly increase as the HST passes by the vicinity of a TRP.

### Machine Learning Methods

Machine learning (ML) has become a popular and promising technique in the field of wireless communications. ML algorithms have a broad range of possible applications, ranging from classification, regression, and prediction to clustering and decision making. ML algorithms may enable devices to learn to efficiently perform some tasks from training data without being explicitly programmed to perform those tasks.

Typically, the learning process may configure a neural network (NN), which may then be used to generate a suitable output to input measurements without the need for an explicit model-based representation of complex systems, such as a cellular network. Examples of ML learning techniques that leverage an NN to learn some tasks may be the more traditional supervised training of neural networks, as well as the actor-critic, Q-learning and federated learning methods.

### Status of 3GPP Discussions

The Rel-17 further enhancement on multiple-input multi-output (feMIMO) for NR work item (WI) was approved in the RAN #86 meeting and was documented in R1-193133 [1]. Within the scope of R1-193133, multi-TRP enhancements are envisioned. Item 2 addresses enhancement on the support for multi-TRP deployment, targeting both frequency 1 (FR1) and frequency 1 (FR2). One sub-objective related to the multi-TRP enhancements is in the topic of HST-SFN, more specifically in items 2.d.i and 2.d.ii. Within the enhancement to support the HST-SFN deployment scenario of item d, item i sets, as a first subobjective, to identify and specify solution(s) on the Quasi Co-Located (QCL) assumption for DeModulation Reference Signal (DMRS), e.g. multiple QCL assumptions for the same DMRS port(s), targeting DL-only transmission. Item ii sets, as a second subobjective, to evaluate and, if the benefit over Rel. 16 HST enhancement baseline is demonstrated, specify QCL/QCL-like relation, including applicable type(s) and the associated requirement, between DL and UL signal by reusing the unified Transmission Configuration Indication (TCI) framework.

One of the analyzed scenarios for HST deployments considered within Rel-17 3GPP discussions is illustrated in the schematic diagram of FIG. 2, where Tracking Reference Signals (TRSs) are transmitted in a TRP-specific manner, and the transmission of the Physical Downlink Control Channel (PDCCH) and Physical Downlink Shared Channel (PDSCH) occur in an SFN manner.

Regarding network (NW)-based solutions for frequency offset pre-compensation, the following agreements were made in the RAN1 #102e meeting [2]. In a first agreement, the following three steps for TRP-based frequency offset pre-compensation scheme were considered for discussion purposes. A first step comprises transmission of the TRS resource(s) from TRP(s) without pre-compensation. A second step comprises transmission of the uplink signal(s)/channel(s) with a carrier frequency determined based on the received TRS signals in the 1st step. A third step comprises transmission of the PDCCH/PDSCH from TRP(s) with frequency offset pre-compensation determined based on the received signal/channel in the 2nd step. A second set of TRS resource(s) may be transmitted at 3rd step.

A second agreement was to study TRP-based frequency offset pre-compensation including the following aspects. A first group of aspects were, aspects related to indication of the carrier frequency determined based on the received TRS resource(s) received in the first step. A first option, Option 1, considered an implicit indication of the Doppler shift(s) using uplink signal(s) transmitted on the carrier frequency acquired in the first step. The first option comprised: a) indication for QCL-like association of the resource(s) received in the first step with UL signal transmitted in the 2nd step and b) type of the uplink reference signals/physical channel used in the second step, necessity of new configuration and corresponding signaling details. A second option, Option 2, considered an explicit reporting of the Doppler shift(s) acquired in the first step using the Channel State Information (CSI) framework. A second option, Option 2, considered: a) for further study (FFS), indication for QCL-like association of the resource(s) received in the first step with UL signal transmitted in the 2nd step, and b) CSI reporting aspects, configuration, quantization, signaling details, etc.

A second aspect of the second agreement were new QCL types/assumption for TRS with other Reference Signal (RS), e.g., Synchronization Signal (SS)/Physical Broadcast Channel (PBCH), when TRS resource(s) may be used as target RS in TCI state.

A third aspect of the second agreement were new QCL types/assumptions for TRS with other RS, e.g., DM-RS, when TRS resource(s) may be used as source RS in the TCI state

A fourth aspect of the second agreement were target physical channels, e.g., PDSCH only or PDSCH/PDCCH, and reference signals that may need to be supported for pre-compensation

A fifth aspect of the second agreement were signaling/procedural details on whether/how the pre-compensation may be applied to target channels.

A sixth aspect of the second agreement were whether multiple sets of TRS and pre-compensation on TRS may be needed in the 3rd step.

Other aspects/schemes were agreed to not be precluded.

In such an NW-based solution, as illustrated in FIG. 1, a TRS may be transmitted in a TRP-specific manner, such that the Doppler pre-compensation can be applied for the transmission of PDCCH/PDSCH, which may be transmitted in an SFN manner. In the RAN1 #102e meeting, some companies evaluated the performance of the NW-based frequency offset pre-compensation solution and concluded that it outperforms the UE-based solution, namely, scheme 1 and scheme 2, as agreed in [2].

Two options for frequency offset pre-compensation were discussed in [3]. The main disadvantage of option 1 from [3], see FIG. 4(a) in [3], is that it requires a continuous and frequent signaling exchange, that is, exchange of TRSs and uplink signaling) between the TRPs and UEs, which increases the signaling overhead, while option 2 from [3], see FIG. 4(b) in [3], requires a continuous exchange of information between the involved TRPs, which is also undesired, as pointed out in [3].

In [4], further analysis regarding the options 1 and 2 from [2] are provided, in which it is concluded that option 2 from [2] requires higher uplink signaling overhead than option 1 from [2], thus option 1 is the preferred option among the options from [2]. Nevertheless, it is worth highlighting that option 1 also requires a continuous and frequent signaling exchange, even though it has a lighter signaling overhead than option 2.

Several options for NW-based frequency pre-compensation are also proposed in [5]. However, all of them rely on signals being exchanged in an always-on fashion between TRPs and UEs. Meanwhile, [6] argues that existing NW-based frequency pre-compensation solutions from the agreements have a considerable signaling overhead, which should be reduced. An enhanced version of the agreed NW-based frequency pre-compensation from [2] is proposed in [7], but it still suffers the same problem mentioned in [6].

### SUMMARY

As part of the development of embodiments herein, one or more challenges with the existing technology will first be identified and discussed.

In [8], the authors discuss the use of prediction-based schemes with applications for 5G high speed train scenarios. In [9], the authors discussed several challenges related to modern railway connectivity. However, none of these references disclose any method for performing frequency offset pre-compensation.

The authors in propose a solution that uses a long short-term memory neural network, which has an offline training phase based on the theoretical values of the Doppler shift and an online training phase based on steps 1, 2 and 3 referred to in the agreement of the in RAN1 #102e meeting [2]. Therefore, the methods disclosed in [10], after their neural network is trained, present the same overhead problems as in [6].

It is an object of embodiments herein to improve the handling of Doppler shift pre-compensation in a wireless communications network.

According to a first aspect of embodiments herein, the object is achieved by a method, performed by a first network node. The method is for handling Doppler shift pre-compensation. The first network node operates in a wireless communications network. The first network node sends a first indication towards a first wireless device. The first indication indicates a start of a training phase. The first network node obtains, directly or indirectly, based on the sent first indication, a set of information from the first wireless device. The set of information indicates a Doppler shift experienced by the first wireless device while moving along a pre-defined trajectory to which a static set of radio network nodes provide radio coverage. The set of information indicates a set of features characterizing how the first wireless device experienced the Doppler shift. The first network node also initiates determining, using machine-learning, and based on the received set of information, a predictive model of Doppler shift pre-compensation. The training phase is of the predictive model.

According to a second aspect of embodiments herein, the object is achieved by a method, performed by the second network node. The method is for handling Doppler shift pre-compensation. The first network node operates in the wireless communications network. The second network node obtains a sixth indication of the Doppler shift experienced by a wireless device while moving along the pre-defined trajectory to which the static set of radio network nodes provide radio coverage. The second network node also determines, based on the obtained sixth indication and after having obtained the sixth indication only once, a Doppler shift pre-compensation value. The determining is based on the predictive model. The predictive model has been determined using machine learning based at least on the trajectory and the static set of radio network nodes serving the trajectory. The second network node also applies the determined Doppler shift pre-compensation value to a second downlink transmission to the wireless device, in response to the obtained sixth indication.

According to a third aspect of embodiments herein, the object is achieved by a method, performed by the wireless device. The method is for handling Doppler shift pre-compensation. The wireless device operates in the wireless communications network. The wireless device receives the first indication from the first network node operating in the wireless communications network. The first indication indicates the start of the training phase of the predictive model of Doppler shift pre-compensation. The wireless device also sends towards the first network node, based on the received first indication, the set of information from the wireless device. The set of information indicates the Doppler shift experienced by the wireless device while moving along the pre-defined trajectory to which the static set of radio network nodes provide radio coverage. The set of information also indicates the set of features characterizing how the wireless device experienced the Doppler shift. The wireless device also receives the first downlink transmission from the first network node. The first downlink transmission is based on the sent set of information.

According to a fourth aspect of embodiments herein, the object is achieved by the first network node, for handling Doppler shift pre-compensation. The first network node is configured to operate in the wireless communications network. The first network node is further configured to send the first indication towards the first wireless device. The first indication is configured to indicate the start of the training phase. The first network node is further configured to obtain, directly or indirectly, based on the first indication configured to be sent, the set of information from the first wireless device. The set of information is configured to indicate the Doppler shift configured to be experienced by the first wireless device while moving along the pre-defined trajectory to which the static set of radio network nodes are configured to provide radio coverage. The set of information is configured to indicate the set of features configured to characterize how the first wireless device is configured to experience the Doppler shift. The first network node is also configured to initiate determining, using machine-learning, and based on the set of information configured to be received, the predictive model of Doppler shift pre-compensation. The training phase is configured to be of the predictive model,

According to a fifth aspect of embodiments herein, the object is achieved by the second network node, for handling Doppler shift pre-compensation. The second network node is configured to operate in the wireless communications network. The second network node is further configured to obtain the sixth indication of the Doppler shift configured to be experienced by the wireless device while moving along the pre-defined trajectory to which the static set of radio network nodes are configured to provide radio coverage. The second network node is further configured to determine, based on the sixth indication configured to be obtained and after having obtained the sixth indication only once, the Doppler shift pre-compensation value. The determining is configured to be based on the predictive model. The predictive model is configured to have been determined using machine learning based at least on the trajectory and the static set of radio network nodes configured to be serving the trajectory. The second network node is further configured to apply the Doppler shift pre-compensation value configured to be determined to the second downlink transmission to the wireless device in response to the sixth indication configured to be obtained.

According to a sixth aspect of embodiments herein, the object is achieved by the wireless device, for handling Doppler shift pre-compensation. The wireless device is configured to operate in the wireless communications network. The wireless device is further configured to receive the first indication from the first network node configured to operate in the wireless communications network. The first indication is configured to indicate the start of the training phase of the predictive model of Doppler shift pre-compensation. The wireless device is further configured to send towards the first network node, based on the first indication configured to be received, the set of information from the wireless device. The set of information is configured to indicate the Doppler shift configured to be experienced by the wireless device while moving along the pre-defined trajectory to which the static set of radio network nodes are configured to provide radio coverage. The set of information is configured to indicate the set of features configured to characterize how the wireless device is configured to have experienced the Doppler shift. The wireless device is also configured to receive the first downlink transmission from the first network node. The first downlink transmission is configured to be based on the set of information configured to be sent.

By the first network node sending the first indication, the first network node may enable to dynamically trigger the training phase of the machine-learning-based predictive model of the Doppler shirt pre-compensation, and in turn facilitate the determination of the predictive model of Doppler shift pre-compensation. The learning approach of embodiments herein may therefore allow to update the learning parameters of the predictive model of Doppler shift pre-compensation when needed, e.g., the training process may be executed upon request. The dynamic update of the predictive model may be enabled by the first network node obtaining the set of features characterizing how the first wireless device 131 may have experienced the Doppler shift.

By the second network node determining the Doppler shift pre-compensation value based on the predictive model having been determined using machine learning, the second network node is enabled to determine the Doppler shift pre-compensation value, after having obtained the sixth indication only once. Therefore, by the first network node enabling to train the predictive model, and the second network node executing it, embodiments herein may be understood to enable that potentially less information may need to be exchanged between the wireless device, e.g., the train or UE, and the set of one or more radio network nodes. The amount of signaling that may be required by the methods described herein may be significantly reduced during its execution phase, compared to the existing methods, e.g., proposed in the RAN1 meetings and in [8-10]. This may be understood to be since steps 1 and 2 from [2] may only need to be executed once per each TRP-UE pair for pre-compensation purposes. Hence, time-frequency resources may be saved, and the determination of the Doppler shift pre-compensation value may be determined more swiftly, reducing overhead.

Furthermore, in contrast to current solutions, which only calculate the Doppler frequency shift for the current train position, embodiments herein may allow for the prediction of the Doppler frequency in future positions of the wireless device.

Embodiments herein may also be advantageously used to train different types of ML models, such as standard neural networks or reinforcement learning-based solutions.

Embodiments herein may further be easily extended to be used in scenarios where two or more gNBs may control different subsets of radio network nodes in the set of one or more radio network nodes 120, e.g., multiple TRPs.

### BRIEF DESCRIPTION OF THE DRAWINGS

Examples of embodiments herein are described in more detail with reference to the accompanying drawings, according to the following description.

FIG. 1 is a schematic diagram illustrating an example of an of an HST communication deployment scenario where multiple TRPs controlled by a gNB are deployed along the train railway, according to existing methods.

FIG. 2 is a schematic diagram illustrating an example of an HST-SFN scenario considered within Rel-17 3GPP discussions.

FIG. 3 is a schematic diagram an example of a wireless communications network, according to embodiments herein.

FIG. 4 is a flowchart depicting a method in a first network node, according to embodiments herein.

FIG. 5 is a flowchart depicting a method in a second network node, according to embodiments herein.

FIG. 6 is a flowchart depicting a method in a wireless device, according to embodiments herein.

FIG. 7 is a signalling diagram illustrating a non-limiting example of a method in a wireless communications network, according to embodiments herein.

FIG. 8 is a signalling diagram illustrating another non-limiting example of a method in a wireless communications network, according to embodiments herein.

FIG. 9 is a schematic block diagram illustrating two embodiments, in panel a) and panel b), of a first network node, according to embodiments herein.

FIG. 10 is a schematic block diagram illustrating two embodiments, in panel a) and panel b), of a second network node, according to embodiments herein.

FIG. 11 is a schematic block diagram illustrating two embodiments, in panel a) and panel b), of a wireless device, according to embodiments herein.

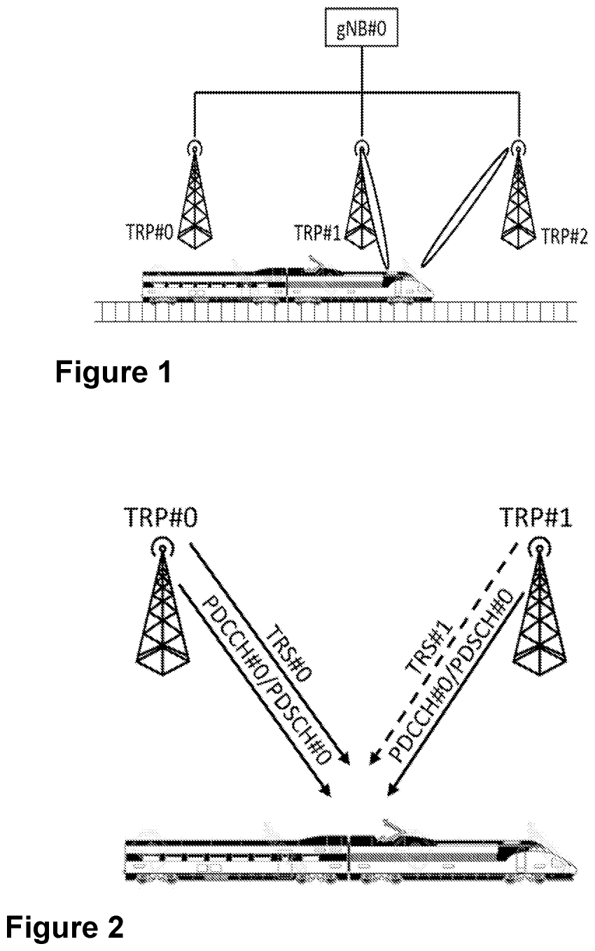

### DETAILED DESCRIPTION

Certain aspects of the present disclosure and their embodiments may provide solutions to the challenges described in the Summary section, or other challenges. From a general point of view, embodiments herein may be generally understood to relate to a learning-based frequency offset pre-compensation for HST.

Embodiments herein may be understood to relate to a method that may allow for an ML-based prediction of Doppler frequency shift and other UE-related parameters performed at the NW side, that is, at the TRPs, gNB and/or cloud, in HST-SFN scenarios. The NW may train ML models, e.g., NNs, using information exchanged between the TRPs and the UE as well as information between the TRPs and the gNB or cloud. Upon finishing the training phase, the amount of signaling exchanged in the system may be significantly reduced. Then, the NW be enabled to predict current and future Doppler frequency shift values and other UE-related parameters based on the trained ML-based model.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

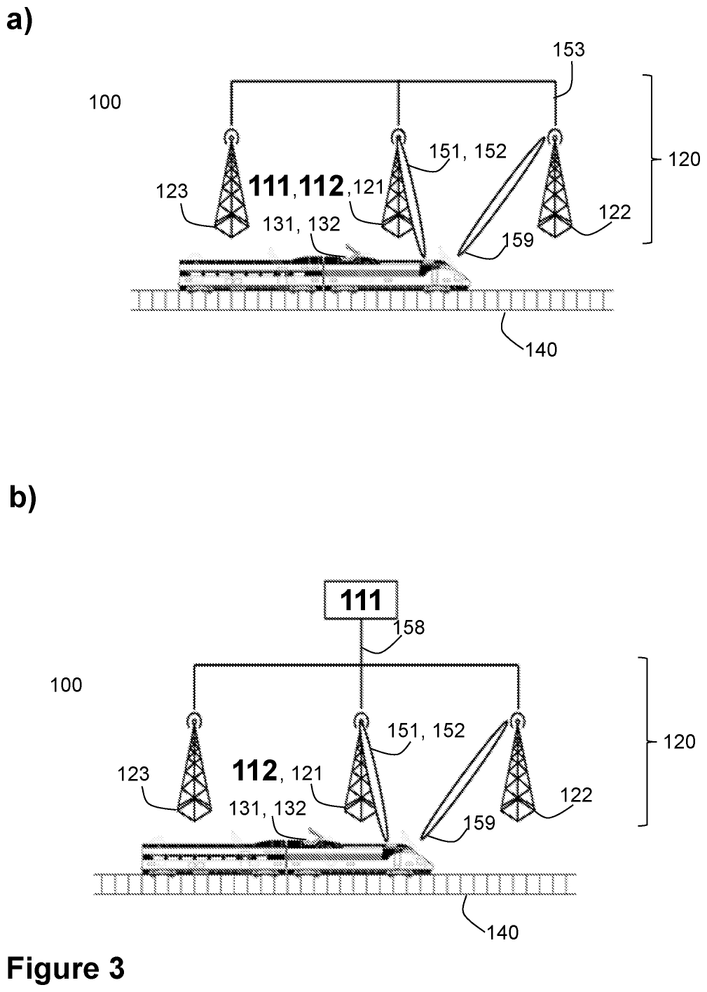

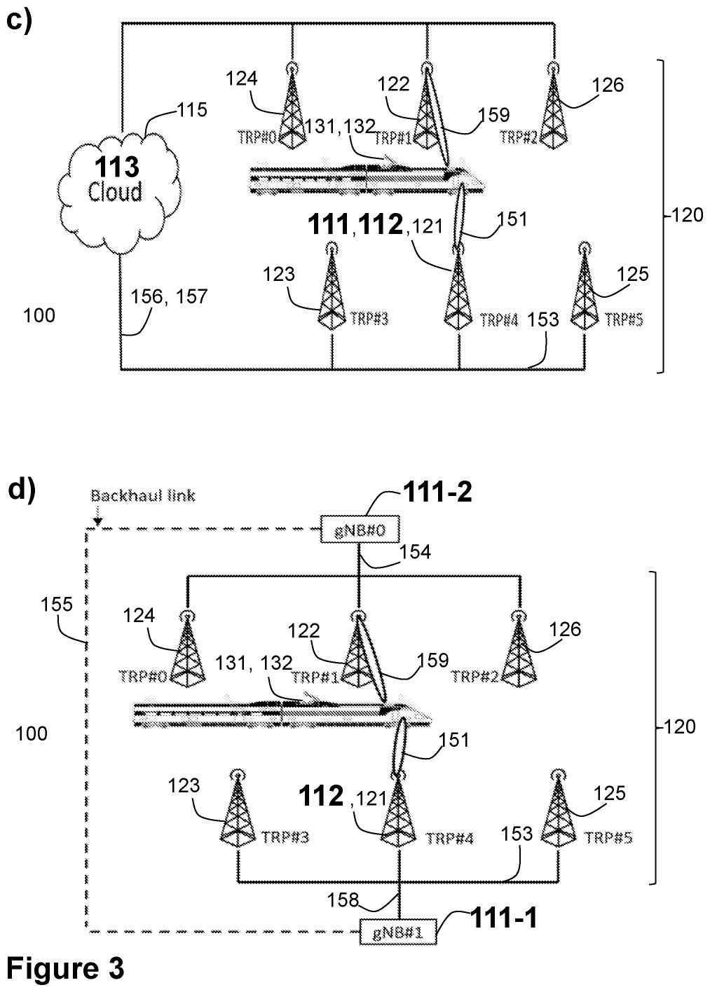

FIG. 3 depicts, in each of panel a), panel b) panel c), and panel d), four non-limiting examples of a wireless communications network 100, sometimes also referred to as a wireless communications system, cellular radio system, or cellular network, in which embodiments herein may be implemented. The wireless communications network 100 may typically be a 5G system, 5G network, NR-U or Next Gen System or network. The wireless communications network 100 may support a younger system than a 5G system. The wireless communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc. . . . Other examples of other technologies the wireless communications network 100 may support may be Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN), Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, NB-IoT, LAA, MulteFire or any cellular network or system. Thus, although terminology from 5G/NR and LTE may be used in this disclosure to exemplify embodiments herein, this should not be seen as limiting the scope of the embodiments herein to only the aforementioned systems.

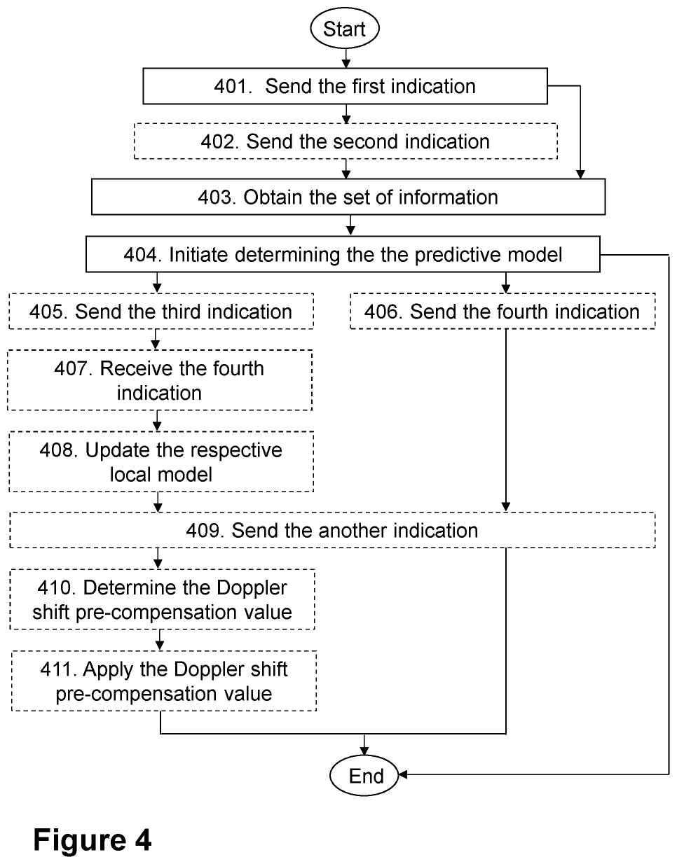

As depicted in FIG. 3, the wireless communications network 100 comprises one or more network nodes, whereof a first network node 111 and a second network node 112 are depicted in the non-limiting examples of FIG. 3. Any of the first network node 111, the second network node 112 and the another network node 113 may be, in some examples such as that depicted in panel a) of FIG. 3, co-located or be the same network node. In typical examples, any of the first network node 111, the second network node 112 and the another network node 113 may be different nodes. In some embodiments, such as that depicted in panel c), the wireless communications network 100 may also comprise another network node 113. Any of the first network node 111, the second network node 112 and the another network node 113 may be understood as a network node, e.g., a radio network node. That is, a transmission point such as a radio base station, for example a gNB, an eNB, or any other network node with similar features capable of serving a wireless device, such as a user equipment or a machine type communication device, in the wireless communications network 100. In typical examples, any of the first network node 111, the second network node 112 and the another network node 113 may be a base station, such as a gNB. In panel b), the first network node 111 is a gNB. In other examples, any of the first network node 111, the second network node 112 and the another network node 113 may be a distributed node, such as a virtual node in the cloud, and may perform its functions entirely on the cloud 115, or partially, in collaboration with a radio network node. In the non-limiting example of panel c), the another network node 113 is depicted as a network node, e.g., a core network node, located in the cloud 115. The first network node 111 may be understood as a network node having a capability to manage a training of a machine-learning predictive model, as will be described in relation to FIG. 3. Any of the first network node 111 and the another network node 113, e.g., TRP and/or gNB and/or cloud, may be equipped with software and/or hardware functionalities that may allow it to build, configure and control one or more neural networks (NNs), which may be needed for the proposed machine learning-based methods to work. This NN may work based on a model, which may comprise a set of weights that may controls its decisions. The second network node 112 may be understood as a network node having a capability to execute a machine-learning predictive model such as that determined by the first network node 111, as will be described in relation to FIG. 4. In some non-limiting examples, the second network node 112 may also be equipped with software and/or hardware functionalities that may allow it to build, configure and control one or more neural networks (NNs), which may be needed for the proposed machine learning-based methods to work. This NN may work based on a model, which may comprise a set of weights that may controls its decisions.

The wireless communications network 100 also comprises a set of radio network nodes 120. In the examples of panel a) and panel b), the set of radio network nodes 120 comprises a first radio network node 121, a second radio network node 122, and a third radio network node 123. In the examples of panel c) and panel d), the set of radio network nodes 120 further comprises a fourth radio network node 124, a fifth radio network node 125, and a sixth radio network node 126. The set of radio network nodes 120 may comprise additional or fewer radio network nodes than those depicted in FIG. 3. Any of the first network node 111, the second network node 112 and the another network node 113 may be one of the radio network nodes in the set of radio network nodes 120, as depicted in the non-limiting examples of panel a), where the first network node 111 and the second network node 112 are co-located and are both comprised in the set of the one or more radio network nodes 120, and panel b), where the second network node 112 is comprised in the set of one or more radio network nodes 120, e.g., as a TRP, and the first network node 111 is a separate network node managing the set of radio network nodes 120, e.g., a gNB.

In some examples, such as that depicted in panel d) of FIG. 3, there may be a plurality of first network nodes 111 connected to different subsets of the set of radio network nodes 120. In the non-limiting example of panel d), a first first network node 111-1 is connected to the first radio network node 121, the third radio network node 123 and the fifth radio network node 125, and a second first network node 111-2 is connected to the fourth radio network node 124, the second radio network node 122 and the sixth radio network node 126. In some examples, such as those depicted in panel d) of FIG. 3, the first radio network node 111 and the second radio network node 112 may be different nodes.

Any of the radio network nodes in the set of radio network nodes 120 may be understood to be a TRP. A TRP may have one or more antenna elements and computational power, e.g., to train a local machine-learning predictive model. A TRP may be available to the network located at a specific geographical location. In the non-limiting examples of FIG. 3, the first radio network node 121 is a first TRP (TRP #4), the second radio network node 122 is a second TRP (TRP #1), the third radio network node 123 is a third TRP (TRP #3), the fourth radio network node 124 is a fourth TRP (TRP #0), the fifth radio network node 125 is a fifth TRP (TRP #5) and the sixth radio network node is a sixth TRP (TRP #2). In some examples, any of the radio network nodes in the set of radio network nodes 120 may be a Remote Radio Head (RHH).

The wireless communications network 100 covers a geographical area which may be divided into cell areas, wherein each cell area may be served by a network node and one or more of the radio network nodes, although, one radio network node may serve one or several cells. Any of the radio network nodes in the set of radio network nodes 120 may transmit one or more beamforming beams.

Any of the first network node 111, the second network node 112, the another network node 113 and of the set of radio network nodes 120 may be of different classes, such as, e.g., macro base station, home base station or pico base station, based on transmission power and thereby also cell size. Any of the first network node 111, the second network node 112, the another network node 113 and of the set of radio network nodes 120 may support one or several communication technologies, and its name may depend on the technology and terminology used. In 5G/NR, any of the first network node 111, the second network node 112 and the another network node 113 may be referred to as a gNB and may be directly connected to one or more core networks.

A plurality of wireless devices may be comprised in the wireless communication network 100, whereof a first wireless device 131, is depicted in the non-limiting examples of FIG. 3. The wireless communication network 100 may also comprise a second wireless device 132.

Any reference herein to wireless device 131, 132 may be understood to refer to any of the first wireless device 131 and the second wireless device 132. In some examples, the first wireless device 131 may be the same wireless device as the second wireless device 132, as depicted in the non-limiting examples of FIG. 3. Any of the first wireless device 131 and the second wireless device 132 comprised in the wireless communications network 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. The wireless device 130 comprised in the wireless communications network 100 is enabled to communicate wirelessly in the wireless communications network 100. The communication may be performed e.g., via a RAN, and possibly the one or more core networks, which may be comprised within the wireless communications network 100. Any of the first wireless device 131 and the second wireless device 132 may be located in a high speed train. For example, any of the first wireless device 131 and the second wireless device 132 may be a CPE mounted on the roof of an HST. Such an example is depicted in the non-limiting examples of FIG. 3, were the first wireless device 131 and the second wireless device 132 are the same.

Any of the first wireless device 131 and the second wireless device 132 may be moving along a pre-defined trajectory 140 to which the set of radio network nodes 120, which may be understood to be a fixed set of radio network nodes 120, may provide radio coverage. The pre-defined trajectory 140 may be, for example, the rail road tracks of an HST.

In examples herein, the execution of the method according to embodiments herein may assume a macro-and-relay layout, in which any of the first network node 111 and/or the second wireless device 132, may be a CPE that may be mounted at the top of one train carriage, and may act as a relay from the one or more radio network nodes 120, e.g., TRPs, to the passenger users inside the train. In this context, the train may be also referred to as a UE, as mentioned in the Background 1. It may also be assumed that the CPE mounted on the train may be capable of decoding multiple signals transmitted using SFN or non-SFN transmission.

The first wireless device 131 may be configured to communicate within the wireless communications network 100 with the first network node 111 over a first link 151, e.g., a radio link, for example a first beam. The first wireless device 131 may be configured to communicate within the wireless communications network 100 with the second network node 112 over a second link 152, e.g., a radio link, for example a second beam. Each of the radio network nodes in the set of radio network nodes 120 may be configured to communicate within the wireless communications network 100 with the first radio network node 111 over a respective third link 153, e.g., a wired link. In examples wherein there the first first network node 111-1 and the second first network node 111-2 may be comprised within the wireless communications network 100, the second first network node 111-2 may be configured to communicate within the wireless communications network 100 with the subset of radio network nodes it may manage over a respective fourth link 154, e.g., a wired link. The first first network node 111-1 may be configured to communicate within the wireless communications network 100 with the second first network node 111-2 over a fifth link 155, e.g., a wired link. The first network node 111 may be configured to communicate within the wireless communications network 100 with the another network node 113 over a sixth link 156, e.g., a wired link. The second network node 112 may be configured to communicate within the wireless communications network 100 with the another network node 113 over a seventh link 157, e.g., a wired link. The second network node 112 may be configured to communicate within the wireless communications network 100 with the first network node 111 over an eighth link 158, e.g., a wired link. Any of the radio network nodes in the set of radio network nodes 120 may be configured to communicate within the wireless communications network 100 with the first wireless device 131 over a respective ninth link 159.

In general, the usage of “first”, “second”, “third”, “fourth”, “fifth” and/or “sixth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

Embodiments of a method, performed by the first network node 111, will now be described with reference to the flowchart depicted in FIG. 4. The method may be understood to be for handling Doppler shift pre-compensation. The first network node 111 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may be understood to be a computer-implemented method.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first network node 111 is depicted FIG. 4. In other examples, one or more of the actions may be performed in a different chronological order than that represented in FIG. 4. In FIG. 4, optional actions are represented with dashed boxes.

The execution of embodiments herein may assume that the first wireless device 131 and optionally, the second wireless device 132, may have already performed the initial access procedure with the network, that is, the first network node 111, e.g., TRPs/gNB.

### Action 401

As mentioned earlier, according to embodiments herein, machine learning-based methods may be executed by the first network node 111 on the network side, e.g., at the TRPs or gNB or CPUs, or in a cloud, that may learn the evolution of the values of the Doppler frequency shift and other parameters related to the first wireless device 131, e.g., the train. This learning may ultimately allow for an ML-based prediction of Doppler frequency shift and other UE-related parameters performed by the first network node 111 on the NW side, e.g., at the TRPs, and/or cloud by building, in later actions, a predictive model of Doppler shift pre-compensation.

In this Action 401, the first network node 111 may send a first indication towards the first wireless device 131. The first indication indicates a start of a training phase. That is, a training phase of the predictive model of Doppler shift pre-compensation. In other words, in this Action 401, the first network node 111 may send a signal to the first wireless device 131 to inform them that a training phase may be begin. The first indication may be, for example, a flag, e.g., a FLAG 0, as it may be referred to in examples herein. When the FLAG-0 may be set to TRUE, it may indicate that the training phase may need to happen.

This Action 401 may be performed only in the beginning of the training phase.

In some embodiments, the first network node 111 may be a network node, e.g., a gNB, managing the set of radio network nodes 120. In such embodiments, the sending 401 of the first indication may be performed via the at least one of the radio network nodes 120 in the set of radio network nodes 120. For example, the first network node 111 may sending a FLAG-0 to the TRPs that when set to TRUE may indicate that the training phase may have to happen.

In some embodiments, the first network node 111 may be one of the radio network nodes in the set of radio network nodes 120, e.g., a TRP. The network node managing the set of radio network nodes 120, e.g., the gNB, may then be the another network node 113. In such embodiments, the first network node 111 may have received a FLAG-0 from the gNB that, when set to TRUE, may indicate that the training phase may have to happen. The first network node 111, as one of the radio network nodes in the set of radio network nodes 120, may then send the FLAG-0 to the first wireless device 131 that, when set to TRUE, may indicate that the training phase may have to happen. According to this, in some embodiments, the sending in this Action 401 of the first indication may be performed after receiving the first indication from the another network node 113, e.g., the gNB managing the set of radio network nodes 120.

That the first network node 111 may send any indication herein “towards” the first wireless device 131 may therefore be understood to mean that the sending may be direct, e.g., from one of the radio network nodes 120, or indirect, from the network node, e.g., a gNB, managing the set of radio network nodes 120.

The sending in this Action 401 may be performed, e.g., via the first link 151.

### Action 402

In this Action 402, the first network node 111 may send a second indication towards the first wireless device 131. The second indication may indicate a change in the periodicity with which the first wireless device 131 is to send the set of information. The second indication may be sent at any point during the training phase.

The second indication may be another flag, e.g., FLAG-1, as it may be referred to in some examples herein. FLAG-1, when set to TRUE, may indicate that the TRS and training signaling periodicity may need to be reduced, so that those signals may be transmitted more frequently to speed up the training phase. For example, FLAG-1, when set to TRUE, may indicate that the periodicity may need to be reduced by half. Alternatively, together with FLAG-1, the first network node 11 may send a new periodicity to be used by the set or radio network nodes 120 and/or first wireless device 131.

In some embodiments, the first network node 111 may be the network node, e.g., a gNB, managing the set of radio network nodes 120. In such embodiments, the sending in this Action 402 of the second indication may be performed via the at least one of the radio network nodes 120 in the set of radio network nodes 120. For example, the gNB may send the new periodicity to be used by the TRPs and UEs.

In some embodiments, the first network node 111 may be one of the radio network nodes in the set of radio network nodes 120, e.g., a TRP. In such embodiments, the first network node 111 may, at any point during the training phase, receive the first indication first from the another network node 113, and then send it to the first wireless device 131. Accordingly, in some embodiments, the sending 402 of the second indication may be performed after receiving the second indication from the another network node 113.

The sending in this Action 402 may be performed, e.g., via the first link 151.

This Action 402 may be performed only during the training phase.

### Action 403

Given that the trajectory of the train is pre-defined, ML-based methods may be used to learn how the Doppler shift may evolve as the train moves. According to embodiments herein, the training phase may be conducted based on information that may characterize the environment and/or behavior of the train along the predefined trajectory 140, such that the adopted ML-based method may learn standard behaviors of the Doppler shift, train velocity, train position, and channel state information, among others.

The set of radio network nodes 120 may transmit TRSs, so that the first wireless device 131, or the set of radio network nodes 120, may be able to estimate the Doppler frequency shifts. After that, the first wireless device 131 may explicitly or implicitly signal an estimation of the Doppler shift to the first network node 111, e.g., to or via TRPs.

In this Action 403, the first network node 111 obtains directly or indirectly, based on the sent first indication, a set of information from the first wireless device 131. The set of information from the first wireless device 131 indicates a Doppler shift experienced by the first wireless device 131 while moving along the pre-defined trajectory 140 to which the static set of radio network nodes 120 provide radio coverage. The set of information from the first wireless device 131 also indicates a set of features characterizing how the first wireless device 131 experienced the Doppler shift.

The obtaining in this Action 403 may be performed, e.g., via the first link 151.

The Doppler frequency offset may be estimated at the first wireless device 131 and/or the set of radio network nodes 120 based on the 3-steps procedure agreed in [2], as described in the Background. For instance, it may be considered the case where the first wireless device 131 may be connected to two TRPs, i.e., TRP1 and TRP2. The TRPs may send TRP-specific TRSs at the downlink frequency fDL. Upon receiving the TRS from TRP1 at frequency fDL+f1 and the TRS from TRP2 at frequency fDL+f2, the first wireless device 131 may report the values of f1 and f2 using the Channel Quality Information (CQI) framework, as proposed in Option 2 from [2]. Note that in this case, the Doppler frequency offset may be estimated at the first wireless device 131. Alternatively, the first wireless device 131 may use Option 1 from [2], in which the first wireless device 131 may implicitly indicate the Doppler shift(s) using uplink signals, e.g., the first wireless device 131 may send an uplink signal at frequency fDL+f1+fDL_UL, frequency difference between uplink and downlink, to TRP1 and at frequency fDL+f2+fDL_UL to TRP2. Then, the TRPs may receive those uplink signals and estimate the Doppler shift.

The set of features characterizing how the first wireless device 131 experienced the Doppler shift may be understood as, e.g., features describing the environment where the first wireless device 131 experienced the Doppler shift or characteristics describing the experience of the Doppler shift.

In some embodiments, the set of features may comprise at least one of the following. In some examples, the set of features may comprise one or more uplink signals transmitted by the first wireless device 131 to indicate the Doppler shift experienced by the first wireless device 131. In some examples, the set of features may comprise a velocity of the first wireless device 131 during the estimation of the Doppler shift. In some examples, the set of features may comprise a direction of movement of the first wireless device 131 during the estimation of the Doppler shift. In some examples, the set of features may comprise a measurement of a quality of a channel with at least one of the radio network nodes in the set of radio network nodes 120. In some examples, the set of features may comprise one or more beams used by the first wireless device 131 to receive one or more downlink signals for which the Doppler shift was experienced.

According to the foregoing it may be understood that in this Action 403, the first wireless device 131 may exchange the set of information, e.g., uplink signals, Doppler frequency shift estimated at the first wireless device 131, UE speed, UE direction of movement, UE position, channel quality measurement performed by the UEs, to train the models located at the network side.

The obtaining in this Action 403 of the set of information may be performed with a periodicity.

### Action 404

According to embodiments herein, the first network 111 may use the set of information received from the first wireless device 131 as input to its ML model or models. In this Action 404, the first network node 111 initiates determining, using machine-learning, and based on the received set of information, a predictive model of Doppler shift pre-compensation. The training phase, the start of which is indicated by the first indication, is of the predictive model.

Initiating may be understood as triggering, enabling, starting, or facilitating.

Determining may be understood as calculating, deriving, generating, or equivalent.

The outputs of the considered NNs may comprise the values of the Doppler frequency shift and/or the values of current or future information related to the first wireless device 131, such as position, some signal quality measurement, currently used beam, speed, direction of movement, etc. . . . Moreover, the set of inputs to the NNs and/or the dataset used for training the NN may comprise locally acquired data, e.g., locally estimated Doppler frequency shift, estimated signal quality, and/or information received from the first wireless device 131 and/or the second wireless device 132, such as Doppler frequency shift estimated at the first wireless device 131, speed of first wireless device 131, direction of movement, first wireless device 131 position, signal quality estimated at the first wireless device 131, and/or information received from the gNB/cloud, e.g., global model and related parameters.

In one embodiment of the method, the set of radio network nodes 120 may respectively keep track of a respective local model for the NN used to predict the Doppler frequency shift and/or the values of current or future information related to the first wireless device 131, such as position, some signal quality measurement, current used beam, velocity, o direction of movement. The updates of the local model at the respective radio network node of the set of radio network nodes 120 may be performed based on information received from the first wireless device 131, e.g., Doppler frequency shift estimated at the first wireless device 131, speed of the first wireless device 131, direction of movement of the first wireless device 131, position of the first wireless device 131, and/or information estimated at the respective radio network node, e.g., Doppler frequency shift estimated at the respective radio network node, speed of the first wireless device 131, direction of movement of the first wireless device 131, position of the first wireless device 131, some channel quality measurement estimated, current used beam, or when the gNB/cloud may transmit a global high-quality model.

In examples wherein the first network node 111 may be the network nodes managing the set of radio network nodes 120, the first network node 111 may initiate determining the predictive model of Doppler shift pre-compensation, which may be a global model.

In examples wherein the first network node 111 may be one of the radio network nodes in the set of radio network nodes 120, the first network node 111 may initiate determining the predictive model of Doppler shift pre-compensation, which may be calculating a respective local model, and/or, enabling that the another network node 113 determines a global model.

### Action 405

According to the foregoing, the first network node 111 may also exchange information among its entities, e.g., between the set of radio network nodes 120, e.g., TRP, and the another network node 113, e.g., gNB/cloud, to update the respective local models, located at the respective radio network nodes, and the global model, located at the another network node 113, e.g., gNB/cloud. In some embodiments wherein the first network node 111 may be one of the radio network nodes 120, as depicted for example, in panel a) of FIG. 3, the determined predictive model may be a respective local model. In some of such embodiments, the first network node 111 may, in this Action 405, send a third indication to the another network node 113 operating in the wireless communications network 100. The third indication may indicate the respective local model.

This Action 405 may be performed only during the training phase.

The sending in this Action 405 may be performed, e.g., via the sixth link 156.

In some particular examples, the first network node 111 may send a set of information to the network node managing the set of radio network nodes 120, e.g., the gNB, comprising at least, but not limited to, the local model, and the values estimated by the local model in the previous time instant.

### Action 406

In some embodiments, wherein the first network node 111 may be different from any of the radio network nodes 120, the obtaining in Action 403 may further comprise receiving a respective local model of the predictive model of Doppler shift pre-compensation determined by at least one of the radio network nodes 120. In such embodiments, the determined predictive model, as initiated in Action 404, may be a global model.

As a result of Action 405, the first network node 111 as a network node managing the set of radio network nodes 120 may have received the set of information from the set of radio network nodes 120 used for global model update containing at least, but not limited to: the local model from each respective radio network node of the set of radio network nodes 120, and the values estimated by local model at the respective radio network nodes of the set of radio network nodes 120 in the previous time instant.

The first network node 11 may then update the global model based on the information received on the previous Action 405.

In one example of the method, the first network node 111 as managing network node, e.g., gNB or cloud, may keep track of a global high-quality model for the NN used by the set of radio network nodes 120. The updates of the global high-quality model at the gNB or cloud may only be performed when the first network node 111 as managing network node may receive the local model from the set of radio network nodes 120, which is when the first network node 111 as managing network node may conduct an aggregation of the received local models and may incorporate this aggregated model in the global high-quality model. Upon finishing this aggregation, the first network node 111 as managing network node may broadcast the global model to the set of radio network nodes 120.

In this Action 406, the first network node 111 may send a fourth indication towards at least one of the radio network nodes 120. The fourth indication may indicate that the respective local model of the predictive model of Doppler shift pre-compensation is to be updated based on the global model. In other words, in this Action 406, the first network node 111 as managing network node may sending a set of information for local model update at the TRPs.

The fourth indication may be, e.g., a flag, such as a FLAG 3 referred to in examples herein. The FLAG-3, when set to TRUE, may indicate that the local model may need to be updated based on the global model.

The sending in this Action 406 may be performed only during the training phase.

The sending in this Action 406 may be performed, e.g., via the sixth link 156.

In some examples of the method, only the first network node 111 as a centralized unit, e.g., a cloud or a gNB that may control the set of radio network nodes 120, may keep track of a global model for the NN used to predict the Doppler frequency shift and/or the values of current or future information related to the first wireless device 131, such as position, some signal quality measurement, currently used beam, velocity and/or direction of movement. The updates of this global model at the first network node 111 as managing network node, e.g., cloud/unique gNB, may be performed based on information received from the first wireless device 131, e.g., Doppler frequency shift estimated at the first wireless device 131, velocity of the first wireless device 131, direction of movement of the first wireless device 131, and/or position of the first wireless device 131, and/or information estimated at the first network node 111 as managing network node, e.g., Doppler frequency shift estimated at the set of radio network nodes 120, velocity of the first wireless device 131, direction of movement of the first wireless device 131, position of the first wireless device 131, some estimated channel quality measurement, currently used beam. In these examples, the set of radio network nodes 120 may only receive signals from the first wireless device 131 and forward them to the first network node 111 as managing network node, without any processing. Furthermore, the set of radio network nodes 120 may only receive signals from the first network node 111 as managing network node and forward them to the first wireless device 131 without any processing.

### Action 407

In some of the embodiments wherein the first network node 111 may be one of the radio network nodes 120 and the determined predictive model may be the respective local model, the first network node 111 may, in this Action 407 receive the fourth indication from the another network node 113, that is, the managing network node. The fourth indication, e.g., the FLAG 3, may indicate that the respective local model of the predictive model of Doppler shift pre-compensation is to be updated based on the global model determined by the another network node 113. In some examples, first network node 111 may, in this Action 407 updating the local model based on the received global model, if FLAG-3 is set to TRUE.

For example, if FLAG-3 is set to TRUE, it may indicate a newly updated global model.

Action 407 may be performed only during the training phase.

The receiving in this Action 407 may be performed, e.g., via the sixth link 156.

### Action 408

In some of the embodiments wherein the first network node 111 may be one of the radio network nodes 120 and the determined predictive model may be the respective local model, the first network node 111 may, in this Action 408, update the respective local model of the predictive model of Doppler shift pre-compensation based on the received fourth indication. In some examples, first network node 111 may, in this Action 408 updating the local model based on the received global model, if FLAG-3 is set to TRUE.

The updating of the local model in this Action 408 may be based at least on the information received in the previous Action 407, but also based on one of the following parameters: Doppler frequency shift estimation performed locally, beam currently used to transmit to the first wireless device 131 and channel quality measurements performed locally.

Action 408 may be performed only during the training phase;

### Action 409

According to the invention, when the training phase finishes, for example, after a preconfigured number of training iterations, or upon convergence of the local and global models, the first network node 111 may send a signal to the first wireless device 131 to inform it to stop the training phase. In this Action 409, the first network node 111 may send another indication towards the first wireless device 131. The another indication may indicate that the training phase may have to stop. The another indication may be another flag, e.g., a FLAG-2,as referred to in some examples of embodiments herein. When set to TRUE, FLAG-2 may indicate that the training phase may stop.

The stop criterion for the training phase may be on the convergence of the global model, maximum number of iterations reserved for training, maximum time reserved for training, or other stop criteria.

Action 409 may be performed only in the end of the training phase.

The sending in this Action 409 may be performed, e.g., via the first link 151.

In examples wherein the first network node 111 may be the network nodes managing the set of radio network nodes 120, the sending in this Action 409 of the another indication may be performed, via the at least one of the radio network nodes 120 in the set of radio network nodes 120.

In some embodiments, the sending in Action 409 of the another indication may be performed after receiving the another indication from the another network node 113. For example, after receiving the FLAG-2 from the network node managing the set of radio network nodes 120, e.g., the gNB, that when set to TRUE may indicate that the training phase may stop.

### Action 410

After having performed Action 409, the first network node 111 may be enabled to send signal information to first wireless device 131 to inform that the execution phase may need to begin.

In this Action 410, the first network node 111 may determine a Doppler shift pre-compensation value for the first wireless device 131 or the second wireless device 132. In other words, the first network node 111 may determine the Doppler shift pre-compensation value for the same wireless device with which it performed the training phase, that is, the first wireless device 131, or for another wireless device, that is, the second wireless device 132. In other words, the first network node 111 may determine the Doppler shift pre-compensation value with a first pool of wireless devices, and then execute the trained model for a second pool of wireless devices, which may or may not partially or totally overlap with the first pool.

The determining in this Action 410 of the Doppler shift pre-compensation value may be based on the updated respective local predictive model.

### Action 411

In this Action 411, the first network node 111 may apply the determined Doppler shift pre-compensation value in a first downlink transmission to the first wireless device 131 or the another wireless device 132.

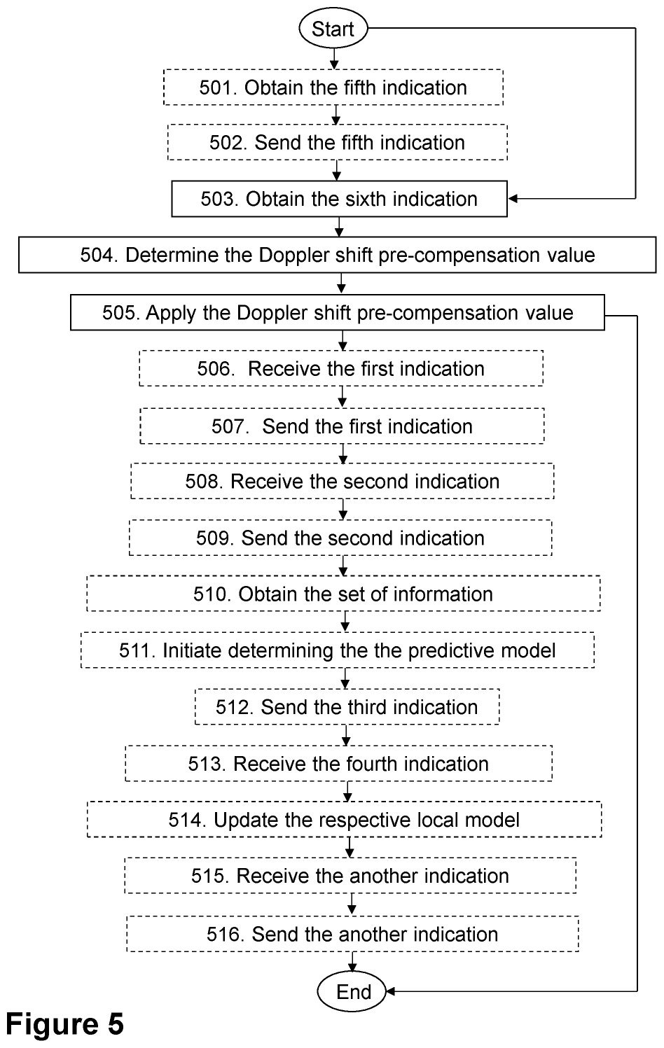

Embodiments of a method, performed by the second network node 112, will now be described with reference to the flowchart depicted in FIG. 5. The method may be understood to be for handling Doppler shift pre-compensation. The second network node 112 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some non-limiting examples, the second network node 112, e.g., TRP and/or gNB and/or cloud, may be equipped with software and/or hardware functionalities that may allow it to build, configure and control one or more neural networks (NNs), which may be needed for the proposed machine learning-based methods to work. This NN may work based on a model, which may comprise a set of weights that may controls its decisions.

The method may be understood to be a computer-implemented method.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second network node 112 is depicted FIG. 5. In other examples, one or more of the actions may be performed in a different chronological order than that represented in FIG. 5. In FIG. 5, optional actions are represented with dashed boxes. The detailed description of some of the following corresponds to the same references provided above, in relation to the actions described for the first wireless device 131, and will thus not be repeated here to simplify the description. For example, the wireless device 131, 132 may be located in the high speed train.

The execution of embodiments herein may assume that the first wireless device 131 and optionally, the second wireless device 132, may have already performed the initial access procedure with the network, that is, the second network node 112, e.g., TRPs/gNB.

### Action 501

In this Action 501, the second network node 112 may receive a fifth indication from the first network node 111 operating in the wireless communications network 100. The fifth indication indicates a start of an execution phase of the predictive model of Doppler shift pre-compensation. The predictive model may have been determined using machine learning based at least on the trajectory 140 and the static set of radio network nodes 112, 113 serving the pre-defined trajectory 140, as described in FIG. 4.

The fifth indication may be another FLAG.

In examples wherein the second network node 112 may be the same as the first network node 111, Action 501 may be performed after having performed Action 409.

The receiving in this Action 501 may be performed, e.g., via the eighth link 158.

### Action 502

In this Action 502, the second network node 112 may send the fifth indication towards the first wireless device 131. The fifth indication, as stated above, may indicate the start of the execution phase of the predictive model of Doppler shift pre-compensation.

The sending in this Action 502 of the fifth indication may be triggered by the obtained fifth indication in Action 501. The second network node 112 may then be enabled to send signal information to the first wireless device 131 to inform that the execution phase may need to begin.

The sending in this Action 502 may be performed, e.g., via the first link 151.

### Action 503

According to the embodiments herein, during the execution phase, the wireless device 131, 132, may send a set of information signals to the network, e.g., the second network 112, once. The second network 112 may then estimate current and future Doppler frequency shifts and other UE-related parameters based on the ML-based predictive model, and thereby be enabled to later transmit pre-compensated PDCCH and PDSCH.

In this Action 503, the second network node 112 obtains a sixth indication of a Doppler shift experienced by the wireless device 131, 132 while moving along the pre-defined trajectory 140, to which the static set of radio network nodes 120 provide radio coverage.

The obtaining 503 of the sixth indication may be triggered by the sent fifth indication.

The obtaining in this Action 503 may be performed, e.g., via the first link 151.

The sixth indication may be, for example, TRSs and uplink signals received from the wireless device 131.

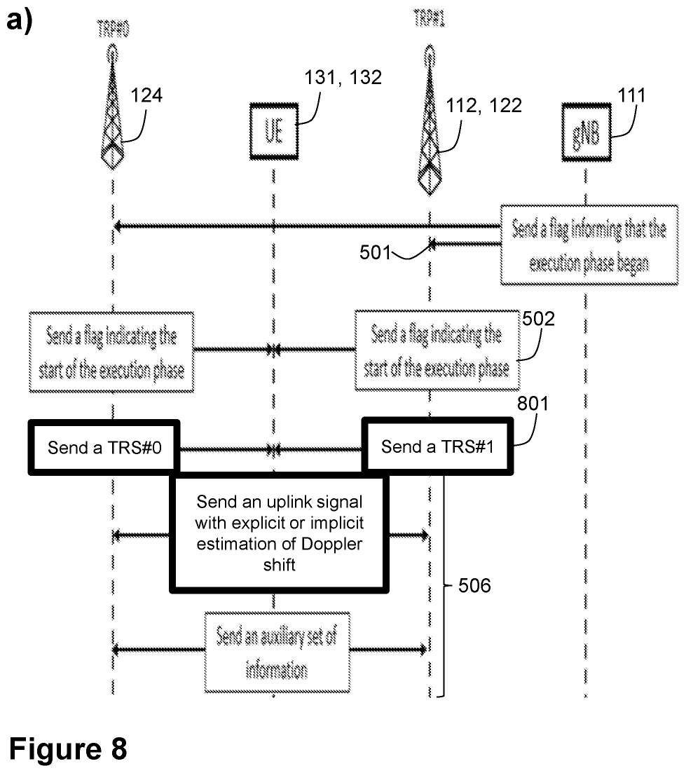

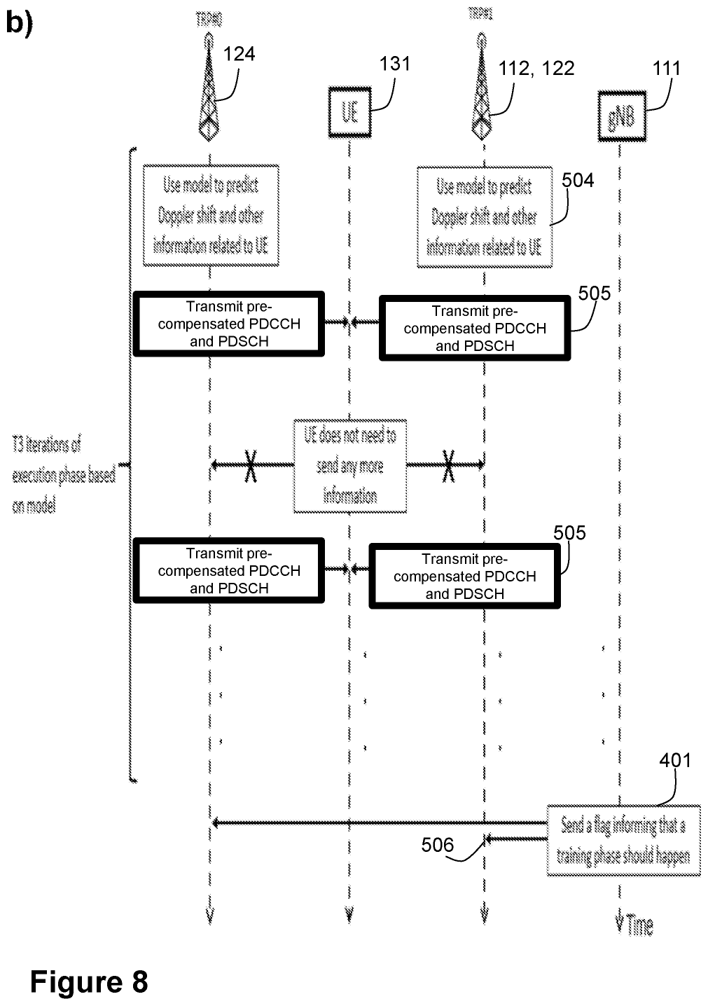

By having determined the predictive model of Doppler shift pre-compensation, e.g., as described in Action 404, after finishing the training phase, in the execution phase, since the pre-defined trajectory 140, that is, the train trajectory, is fixed, the amount of signaling that may be required by the method described herein may be understood to be significantly reduced, see FIG. 8, compared to existing methods. This may be understood to be since steps 1 and 2referred to in the agreement of the in RAN1 #102e meeting [2], may be understood to only need to be executed once per each radio network node-wireless device 131, 132, e.g., TRP-UE, pair for pre-compensation purposes.

### Action 504

In this Action 504, the second network node 112 determines, based on the obtained sixth indication and after having obtained the sixth indication only once, a Doppler shift pre-compensation value. The determining in this Action 504 is based on the predictive model. The predictive model has been determined using machine learning based at least on the trajectory 140 and the static set of radio network nodes 112, 113 serving the trajectory 140, as e.g., described in relation to FIG. 4. That is, in this Action, the second network node 112 may use the trained model to predict the Doppler frequency shift and other information related to the wireless device 131, 132.

Determining may be understood as calculating, deriving, generating, or equivalent.

This Action 504 may be performed only after the training phase, that is, after the predictive model may have been properly trained.

### Action 505

In this Action 505, the second network node 112, applies the determined Doppler shift pre-compensation value to a second downlink transmission to the wireless device 131, 132, in response to the obtained sixth indication. The second downlink transmission may be PDCCH and PDSCH. In other words, in this Action 505 the second network node 112 may send pre-compensated PDCCH and PDSCH to the wireless device 131, 132, where the pre-compensation may be based on TRSs and uplink signals received from the wireless device 131, 132, or based on the current estimation of the predictive model.

### Action 506

In some embodiments, the second network node 112 may in this Action 503 receive the first indication from the first network node 111 operating in the wireless communications network 100. The first indication, as described earlier, may indicate the start of the training phase of the predictive model of the Doppler shift pre-compensation. That is, the execution and iteration phases may iterate.

The receiving in this Action 506 may be performed, e.g., via the eighth link 158.

Action 506 may be performed only at the beginning of the training phase.

### Action 507

In this Action 507, the second network node 112 may send the first indication towards the first wireless device 131.

Action 507 may be performed only during the training phase.

The sending in this Action 507 may be performed, e.g., via the first link 151.

### Action 508

In this Action 508, the second network node 112 may receive the second indication from the first network node 111. The second indication, as described earlier, may indicate the change in the periodicity with which the first wireless device 131 may have to send the set of information.

Action 508 may be performed only during the training phase.

The receiving in this Action 508 may be performed, e.g., via the eighth link 158.

### Action 509

In this Action 509, the second network node 112 may send the second indication towards the first wireless device 131.

Action 509 may be performed only in the end of the training phase.

The sending in this Action 509 may be performed, e.g., via the first link 151.

### Action 510

In this Action 510, the second network node 112 may obtain, directly or indirectly, based on the sent first indication, the set of information from the first wireless device 131. The set of information may indicate, as described earlier: i) the Doppler shift experienced by the first wireless device 131 while moving along the pre-defined trajectory 140 to which the static set of radio network nodes 120 provide the radio coverage, and ii) the set of features characterizing how the first wireless device 131 experienced the Doppler shift.

In some embodiments, the set of features may comprise at least one of: a) the one or more uplink signals transmitted by the first wireless device 131 to indicate the Doppler shift experienced by the first wireless device 131, b) the velocity of the first wireless device 131 during the estimation of the Doppler shift, c) the direction of movement of the first wireless device 131 during the estimation of the Doppler shift, d) the measurement of the quality of the channel with at least one of the radio network nodes in the set of radio network nodes 120, and e) the one or more beams used by the first wireless device 131 to receive one or more downlink signals for which the Doppler shift was experienced.

In some embodiments wherein the obtaining in this Action 510 of the set of information may be performed with the periodicity, the method may further comprise performing Action 508 and Action 509.

The obtaining in this Action 510 may be performed, e.g., via the first link 151.

### Action 511

In this Action 511, the second network node 112 may initiate determining, using machine-learning, and based on the received set of information, the predictive model of Doppler shift pre-compensation.

### Action 512

In some embodiments wherein the second network node 112 may be one of the radio network nodes 120, and the determined predictive model may be the respective local model, in this Action 512, the second network node 112 may send the third indication to the another network node 113 operating in the wireless communications network 100. The third indication may indicate the respective local model.

The sending in this Action 512 may be performed, e.g., via the seventh link 157.

### Action 513

In some embodiments wherein the second network node 112 may be one of the radio network nodes 120, and the determined predictive model may be the respective local model, in this Action 513, the second network node 112 may receive the fourth indication from the another network node 113. The fourth indication may indicate that the respective local model of the predictive model of Doppler shift pre-compensation may need to be updated based on the global model determined by the another network node 113.

The receiving in this Action 513 may be performed, e.g., via the seventh link 157.

### Action 514

In some embodiments wherein the second network node 112 may be one of the radio network nodes 120, and the determined predictive model may be the respective local model, in this Action 514, the second network node 112 may update the respective local model of the predictive model of Doppler shift pre-compensation based on the received fourth indication.

### Action 515

In this Action 515, the second network node 112 may receive the another indication from the first network node 111. The another indication may indicate that the training phase is to stop.

The receiving in this Action 515 may be performed, e.g., via the seventh link 157.

Action 515 may be performed only at the end of the training phase.

### Action 516

In this Action 516, the second network node 112 may send the another indication towards the first wireless device 131.

The sending in this Action 516 may be performed, e.g., via the first link 151.

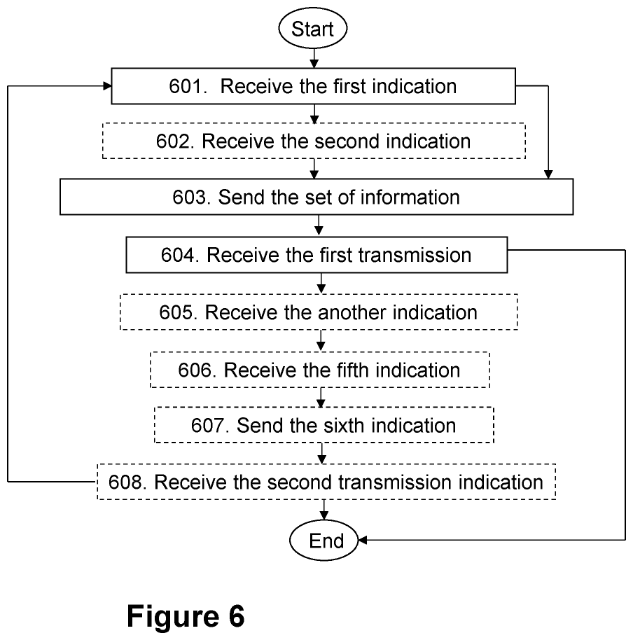

Embodiments of a method, performed by the wireless device 131, 132, will now be described with reference to the flowchart depicted in FIG. 6. The method may be understood to be for handling Doppler shift pre-compensation. The wireless device 131, 132 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some non-limiting examples, any of the first network node 111 and the second network node 112, e.g., TRP and/or gNB and/or cloud, may be equipped with software and/or hardware functionalities that may allow it to build, configure and control one or more neural networks (NNs), which may be needed for the proposed machine learning-based methods to work. This NN may work based on a model, which may comprise a set of weights that may controls its decisions.

The method may be understood to be a computer-implemented method.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the wireless device 131, 132 is depicted FIG. 6. In other examples, one or more of the actions may be performed in a different chronological order than that represented in

FIG. 6. In FIG. 6, optional actions are represented with dashed boxes. The detailed description of some of the following corresponds to the same references provided above, in relation to the actions described for the first wireless device 131, and will thus not be repeated here to simplify the description. For example, the wireless device 131, 132 may be located in the high speed train.

The execution of embodiments herein may assume that the first wireless device 131 and optionally, the second wireless device 132, may have already performed the initial access procedure with the network, that is, the second network node 112, e.g., TRPs/gNB.

### Action 601

In this Action 601, the wireless device 131, 132 receives the first indication from the first network node 111 operating in the wireless communications network 100. The first indication indicates the start of the training phase of the predictive model of Doppler shift pre-compensation. In particular examples, this Action 501 may comprise receiving the FLAG-0 from the TRPs that, when set to TRUE, may indicate that the training phase may need to happen.

Action 601 may be performed only in the beginning of the training phase.

The receiving in this Action 601 may be performed, e.g., via the first link 151.

### Action 602

In this Action 602, the wireless device 131, 132 may receive the second indication from the first network node 111. The second indication may indicate the change in the periodicity with which the wireless device 131, 132 may have to send the set of information. For example, optionally, at any point during the training phase, Action 602 may comprise receiving the FLAG-1 from the TRPs that when set to TRUE may indicate that the TRS and training signaling periodicity may need to be reduced.

Action 602 may be performed only in the beginning of the training phase.

The receiving in this Action 602 may be performed, e.g., via the first link 151.

### Action 603

The wireless device 131, 132 may then receiving TRSs from one or more of the set of radio network nodes 120.

In this Action 603, the wireless device 131, 132 sends, towards the first network node 111, based on the received first indication, the set of information from the wireless device 131, 132. The set of information indicates: i) the Doppler shift experienced by the wireless device 131, 132 while moving along the pre-defined trajectory 140 to which the static set of radio network nodes 120 provide radio coverage, and ii) the set of features characterizing how the wireless device 131, 132 experienced the Doppler shift.

In some embodiments, the set of features may comprise at least one of: a) the one or more uplink signals transmitted by the wireless device 131, 132 to indicate the Doppler shift experienced by the wireless device 131, 132, b) the velocity of the wireless device 131, 132 during the estimation of the Doppler shift, c) the direction of movement of the wireless device 131, 132 during the estimation of the Doppler shift, d) the measurement of the quality of the channel with at least one of the radio network nodes in the set of radio network nodes 120, and e) the one or more beams used by the wireless device 131, 132 to receive the one or more downlink signals for which the Doppler shift was experienced.

The sending in this Action 603 may be performed, e.g., via the first link 151.

In some examples, Action 605 may comprise the wireless device 131, 132 sending the uplink signal with the explicit or implicit estimation of the Doppler frequency shift performed locally. Action 605 may also comprise the wireless device 131, 132 sending the set of information to the one or more of the set of radio network nodes 120 comprising at least, but not limited to: speed, direction of movement, position, and channel quality measurements performed locally.

In some embodiments wherein the obtaining in this Action 603 of the set of information may be performed with the periodicity, the wireless device 131, 132 may have performed Action 602.

### Action 604

In this Action 604, the wireless device 131, 132 receives the first downlink transmission from the first network node 111. The first downlink transmission is based on the sent set of information. For example, the wireless device 131, 132 may receive the pre-compensated PDCCH and PDSCH from the one or more of the set of radio network nodes 120.

The receiving in this Action 604 may be performed via, e.g., via the first link 151.

### Action 605

In this Action 605, the wireless device 131, 132 may receive the another indication from the first network node 111. The another indication may indicate that the training phase is to stop. For example, the wireless device 131, 132 may receive the FLAG-2 from the one or more of the set of radio network nodes 120 that when set to TRUE may indicate that the training phase may stop.

The receiving in this Action 605 may be performed via, e.g., via the first link 151.

Action 605 may be performed only at the end of the training phase.

### Action 606

In this Action 606, the wireless device 131, 132 may receive the fifth indication from a second network node 112 operating in the wireless communications network 100. The fifth indication may indicate the start of the execution phase of the predictive model of Doppler shift pre-compensation.

The receiving in this Action 606 may be performed via, e.g., via the second link 152.

### Action 607

In this Action 607, the wireless device 131, 132 may send, to the second network node 112, the sixth indication of the Doppler shift experienced by the wireless device 131, 132 while moving along the pre-defined trajectory 140. The sending in this Action 607 of the sixth indication may be triggered by the received fifth indication.

The sending in this Action 607 may be performed via, e.g., via the second link 152.

### Action 608

In this Action 608, the wireless device 131, 132 may receive a second downlink transmission from the second network node 112. The second downlink transmission may be based on the sent sixth indication.

The sending in this Action 608 may be performed, e.g., via the second link 152.

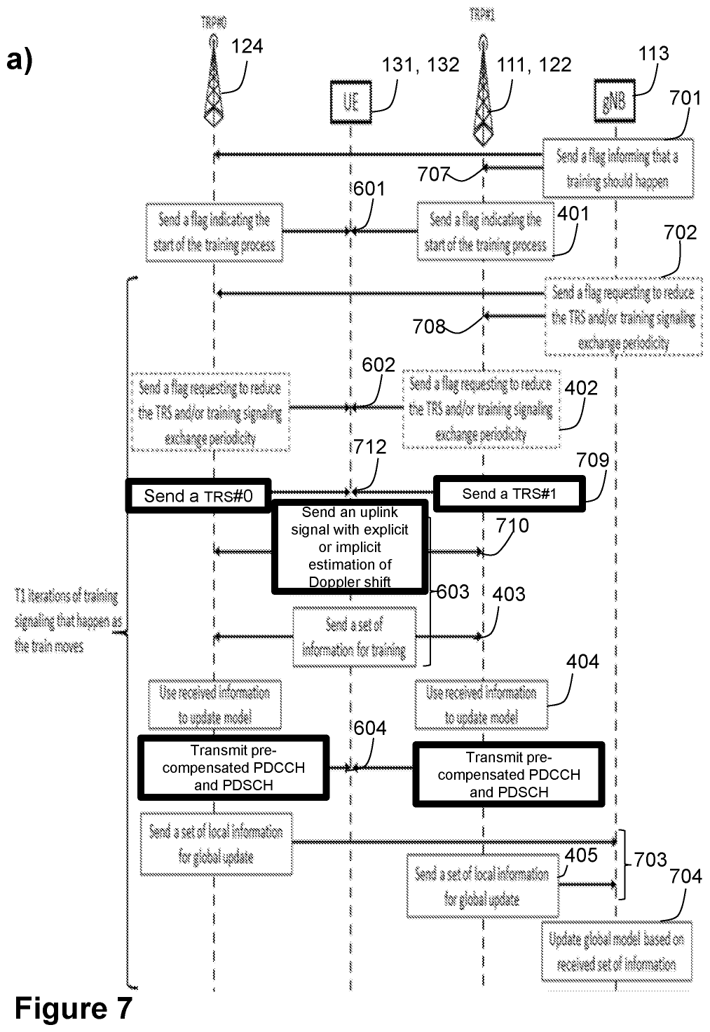

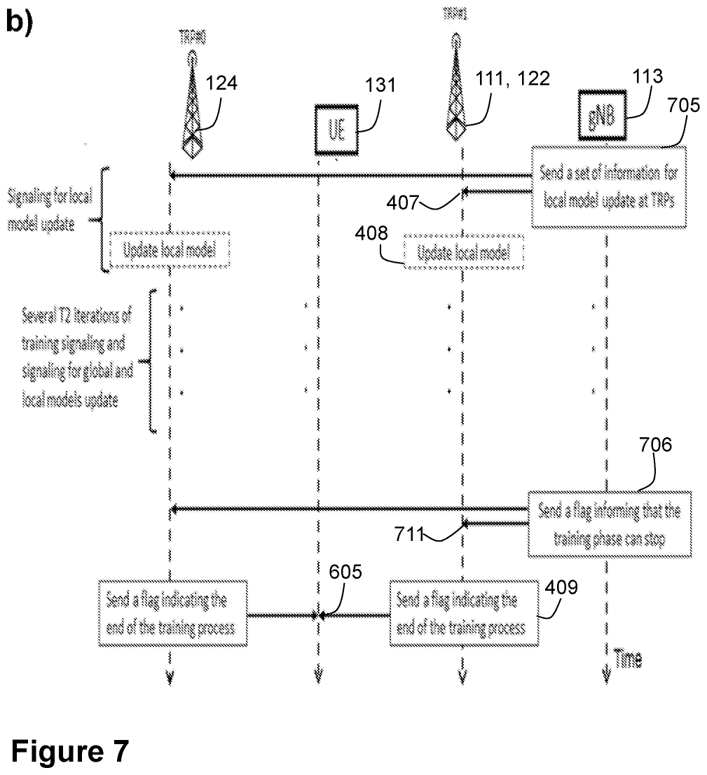

FIG. 7 is a signalling diagram depicting a non-limiting example of the signaling exchange during the training phase according to methods performed by the first network node 111, the another node 113 and the wireless device 131, 132, according to embodiments herein. The method starts with the steps in panel a) and continues with the steps in panel b). In this example, the first wireless device 131 and the second wireless device 132 are the same wireless device 131, 132, a UE. FIG. 7 illustrates the signaling exchange between UEs, TRPs and gNBs during the training phase of the described method. The boxes with bold frames represent the signaling that is currently under discussion within 3GPP to be included in the 3GPP standard. The remaining boxes represent the novel signaling according to embodiments herein. Therefore, the training phase shown in FIG. 7 may be understood to involve additional signaling and additional exchange of information compared to a ‘normal operation mode’. For instance, the training phase described in FIG. 7 may be understood as an online training phase that may be used when adopting a reinforcement learning-based algorithm, in which the algorithm may learn based on the interaction with the environment. Moreover, using the signaling described in embodiments herein, it may be possible to perform an online training of a neural network or improve an offline-trained neural network based on the transfer learning described. However, at the same time, if the described training phase is understood as a “data-collection phase”, it may still require additional signaling compared to the “normal operation mode”. As may be observed in FIG. 7, embodiments herein, as described for the first network node 111 may be divided into two groups of embodiments, wherein in one group of embodiments, the first network node 111 may be the network node managing the set of radio network nodes 120 and the actions may be executed by the gNB, and in another group of embodiments, the first network node 111 may be one of the radio network nodes in the set of radio network nodes 120 and the actions may be executed by the TRPs. To simplify the description of the two groups of embodiments, in the non-limiting example of FIG. 7, the first network node 111 is the second radio network node 122, represented as TRP #1, and the another network node 113 is a gNB managing the first network node 111. The set of radio network nodes 120 also comprises the fourth radio network node 124, represented as TRP #0. The method executed by the another node 113, here an gNB, which in other examples that that depicted in FIG. 7 may itself be the first network node 111, comprises the following steps. In step 701, the another node 113 sends the FLAG-0 to the TRPs that when set to TRUE indicates that a training phase may have to happen. This step may be performed only in the beginning of the training phase. Optionally, at any point during the training phase, the another node 113, at 702, may send a FLAG-1 to the TRPs that when set to TRUE indicates that the TRS and training signaling periodicity may have to be reduced so that those signals are transmitted more frequently to speed up the training phase. FLAG-1 when set to TRUE may indicate that the periodicity may have to be reduced by half. Alternatively, together with FLAG-1, the gNB may send the new periodicity to be used by the TRPs and UEs. This step may be performed only during the training phase. At 703, the another node 113 may receive a set of information from the TRPs used for global model update containing at least, but not limited to the local model from each TRP, and the values estimated by local model at TRPs in the previous time instant. This step may be performed only during the training phase. At 704, the another node 113 may update the global model based on the information received on the previous step. This step may be performed only during the training phase. At 705, the another node 113 may send a set of information for local model update at the TRPs. The FLAG-3 when set to TRUE indicates that the local model may have to be updated based on the global model. The another node 113 may send the newly updated global model, if FLAG-3 is set to TRUE. This step may be performed only during the training phase. At 706, the another node 113 may send a FLAG-2 that when set to TRUE indicates that the training phase may stop. The stop criterion for the training phase may be on the convergence of the global model, maximum number of iterations reserved for training, maximum time reserved for training, or other stop criteria. This step may be performed only in the end of the training phase. The method executed by the TRP as first network node 111, may comprise the following steps. At 707, the first network node 111 may receive a FLAG-0 from the gNB that when set to TRUE indicates that a training phase may have to happen. This step may be performed only in the beginning of the training phase. In accordance with Action 401, the first network node 111 may send a FLAG-0 to the UEs that when set to TRUE indicates that a training phase may have to happen. This step may be performed only in the beginning of the training phase. Optionally, at any point during the training phase, the first network node 111 may receive a FLAG-1 from the gNB that when set to TRUE indicates that the TRS and training signaling periodicity may have to be reduced. This step may be performed only during the training phase. Optionally, at any point during the training phase, in accordance with Action 402, the first network node 111 may send a FLAG-1 to the UEs that when set to TRUE indicates that the TRS and training signaling periodicity should be reduced. This step may be performed only during the training phase. At 709, the first network node 111 may send TRSs to the UEs. At 710, the first network node 111 may receive an uplink signal from the UEs with explicit or implicit estimation of Doppler frequency shift performed at the UEs. In accordance with Action 403, the first network node 111 may receive the set of information from the UEs for training the local model containing at least, but not limited to: speed of the UEs, UEs direction of movement, UEs position, and channel quality measurement performed by the UEs. In accordance with Action 404, the first network node 111 may update the local model based at least on the information received in the previous step, but also based on one of the following parameters: Doppler frequency shift estimation performed locally, beam currently used to transmit to the UEs, and channel quality measurements performed locally. This step may be performed only during the training phase. In accordance with Action 405, the first network node 111 may send the set of information to the gNB containing at least, but not limited to: the local model, and the values estimated by local model in the previous time instant. This step may be performed only during the training phase. In accordance with Action 407, the first network node 111 may receive, from the gNB, a set of information for local model update. A FLAG-3 when set to TRUE indicates that the local model may have to be updated based on the global model. The newly updated global model may be indicated if FLAG-3 is set to TRUE. This step may be performed only during the training phase. In accordance with Action 408, the first network node 111 may update the local model based on the received global model, if FLAG-3 is set to TRUE. This step may be performed only during the training phase. At 711, the first network node 111 may receive a FLAG-2 from the gNB that when set to TRUE indicates that the training phase can stop. This step may be performed only in the end of the training phase. In accordance with Action 409, the first network node 111 may send a FLAG-2 to the UEs that when set to TRUE indicates that the training phase may stop. This step may be performed only in the end of the training phase. The method executed by the UE may comprise the following steps. In accordance with Action 601, the wireless device 131, 132 may receive a FLAG-0 from the TRPs that when set to TRUE indicates that a training phase may have to happen. This step may be performed only in the beginning of the training phase. Optionally, at any point during the training phase, in accordance with Action 602, the wireless device 131, 132 may receive a FLAG-1 from the TRPs that when set to TRUE indicates that the TRS and training signaling periodicity may have to be reduced. This step may be performed only during the training phase. At 712, the wireless device 131, 132 may receive TRSs from the TRPs. In accordance with Action 603, the wireless device 131, 132 may send an uplink signal with explicit or implicit estimation of Doppler frequency shift performed locally, and send the set of information to the TRPs containing at least, but not limited to: speed, direction of movement, position, and channel quality measurement performed locally. In accordance with Action 604, the first network node 111 may receive the pre-compensated PDCCH and PDSCH from the TRPs. In accordance with Action 605, the wireless device 131, 132 may receiving a FLAG-2 from the TRPs that when set to TRUE indicates that the training phase may have to stop. This step may be performed only in the end of the training phase.

FIG. 8 is a signalling diagram depicting another non-limiting example of the signaling exchange between UEs, TRPs and gNBs during the execution phase according to methods performed by the second network node 112, the another node 113 and the wireless device 131, 132, according to embodiments herein. The method starts with the steps in panel a) and continues with the steps in panel b). In this example, the first wireless device 131 and the second wireless device 132 are the same wireless device 131, 132, a UE. In the non-limiting example of FIG. 8, the second network node 112 is the second radio network node 122, represented as TRP #1, and the first network node 111 is a gNB managing the second network node 112. The set of radio network nodes 120 also comprises the fourth radio network node 124, represented as TRP #0. The boxes with bold frames represent the signaling that is currently under discussion within 3GPP to be included in the 3GPP standard. The remaining boxes represent the novel signaling according to embodiments herein. Therefore, the execution phase shown in FIG. 8 requires additional signaling and additional exchange of information compared to a ‘normal operation mode’. The method executed by the TRP as second network node 112, may comprise the following steps. In accordance with Action 501, the second network node 112 may receive a flag from the first network node 111 informing that the execution phase began. In accordance with Action 501, the second network node 112 may send the flag informing that the start of the execution phase to the wireless device 131, 132. At 801, the second network node 112 may send a TRS #1 to the wireless device 131, 132. In accordance with Action 506, the second network node 112 may receive the uplink signal with the explicit or implicit estimation of the Doppler shift experienced by the wireless device 131, 132 as well as the, auxiliary, set of information. In accordance with Action 504, the second network node 112 may use the trained model to predict the Doppler frequency shift and other information related to the UE. This step may be performed only after the training phase, i.e., after the model may have been properly trained. In accordance with Action 505, the second network node 112 may send pre-compensated PDCCH and PDSCH to the UEs, where the pre-compensation may be based on TRSs and uplink signals received from the UEs or based on the current estimation of the model. It may be noted that after the ML model may have been trained, the amount of signaling required by the method described according to embodiments herein may be is significantly reduced during its execution phase, as depicted in FIG. 8, compared to the methods proposed in the RAN1 meetings and in [7,8,9]. This may be understood to be since steps 1 and 2 from [2] may only need to be executed once per each TRP-UE pair for pre-compensation purposes. This is illustrated in FIG. 8, panel b), by the box “UE does not need to send any more information”. In accordance with Action 505, the second network node 112 may, in another iteration of Action 505, send pre-compensated PDCCH and PDSCH to the UEs, where the pre-compensation may be based on TRSs and uplink signals received from the UEs or based on the current estimation of the model. In accordance with Action 506, the second network node 112 may receive a flag informing that the training phase may need to happen, which may have been sent by the first network node 111 in accordance with Action 401.

Implementation for Scenarios With a Cloud or With More Than Two gNBs

In HST communication, the described methods may be executed following the same actions described above in scenarios in which the first network node 111 may be a cloud entity that may control the set of one or more radio network nodes 120, e.g., all the TRPs, similar to the scenario illustrated in FIG. 3, panel c) for the another node 113. The only difference may be that instead of communicating with a gNB, the set of one or more radio network nodes 120 may be exchanging information with the cloud 115.

Considering scenarios in which the wireless device 131, 132 may be served by or connected to the set of one or more radio network nodes 120 that may be controlled by different gNBs, such as illustrated in FIG. 3, panel d), the described methods may require a backhaul link to exist between the involved gNBs. Such a backhaul link may be used by the gNBs to exchange their models, aggregate them into a single model, and then each gNB may transmit its aggregated model to the subset of the radio network nodes of the set of one or more radio network nodes 120 it may be controlling.

Implementation for Scenarios Where the TRPs Communicate Directly Without the Need to Resort to the gNB/Cloud

One additional possible deployment option for embodiments herein may be in the case where the set of one or more radio network nodes 120 may communicate directly, that is, without the need to resort to a gNB/Cloud, such as illustrated in FIG. 3, panel a). In this case, one radio network node in the set of one or more radio network nodes 120 may be preconfigured to act as a ‘master’ radio network node, e.g., TRP, to store the global model, besides its local model, and to perform the functions previously executed by gNB/cloud in the previous case, e.g., controlling the beginning and end of the training phase by sending signals to the set of one or more radio network nodes 120, so that they may send signals, e.g., flags, to the wireless device 131, 132, aggregating the local models received from other radio network nodes into a global model, updating the global model, sending the updated global model to the other radio network nodes in the set of one or more radio network nodes 120. The remaining actions of the embodiments herein may remain the same or may be easily deduced by the skilled person

Certain embodiments disclosed herein may provide one or more of the following technical advantage(s), which may be summarized as follows. As a first advantage, embodiments herein may be understood to enable that potentially less information may need to be exchanged between the wireless device 131, 132, e.g., the train or UE, and the set of one or more radio network nodes 120. The amount of signaling that may be required by the methods described herein may be significantly reduced during its execution phase, see FIG. 8, compared to the solutions proposed in the RAN1 meetings and in [8-10]. This may be understood to be since steps 1 and 2 from [2] may only need to be executed once per each TRP-UE pair for pre-compensation purposes.

As a second advantage, embodiments herein, may be understood to enable that, in contrast to current solutions, which only calculate the Doppler frequency shift for the current train position, embodiments herein may allow for the prediction of the Doppler frequency in future wireless device 131, 132, e.g., train, positions.

Embodiments herein may also be advantageously used to train different types of ML models, such as standard neural networks or reinforcement learning-based solutions.

As a further advantage, the learning approach of embodiments herein may allow the set of one or more radio network nodes 120 to update the learning parameters when needed, e.g., the training process may be executed upon request.

Embodiments herein may further be easily extended to be used in scenarios where two or more gNBs may control different subsets of radio network nodes in the set of one or more radio network nodes 120, e.g., multiple TRPs.

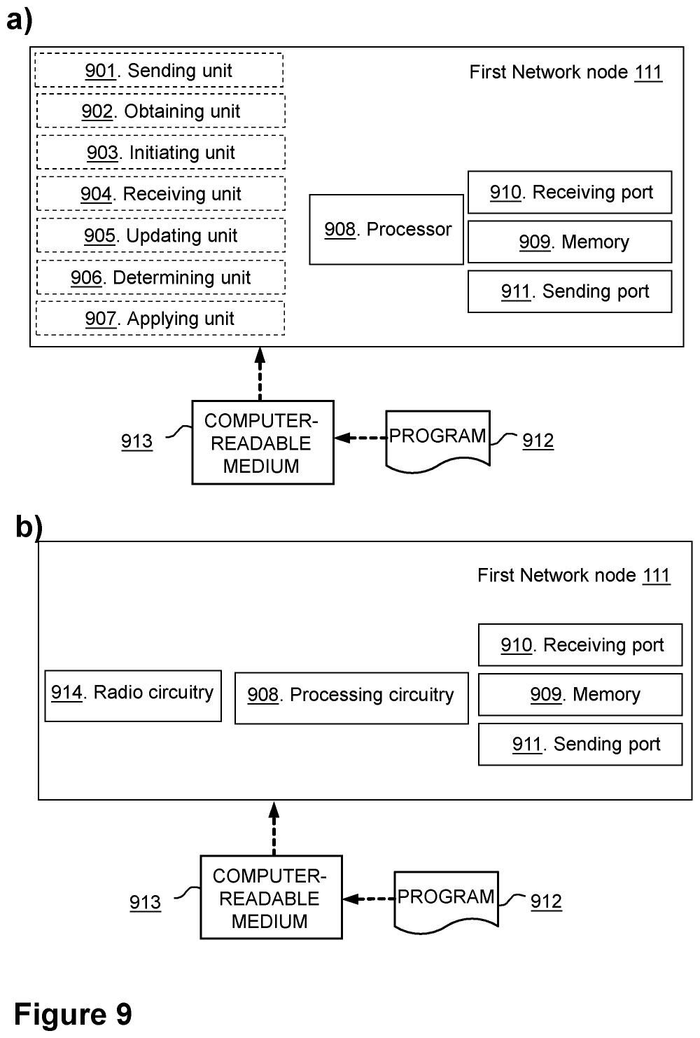

FIG. 9 depicts two different examples in panels a) and b), respectively, of the arrangement that the first network node 111 may comprise to perform the method actions described above in relation to FIG. 4. In some embodiments, the first network node 111 may comprise the following arrangement depicted in FIG. 9a. The first network node 111 may be understood to be for handling Doppler shift pre-compensation. The first network node 111 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111 and will thus not be repeated here. For example, the wireless device 131, 132 may be configured to be located in the high speed train.

In FIG. 9, optional units are indicated with dashed boxes.

The first network node 111 is configured to, e.g. by means of a sending unit 901 within the first network node 111, configured to send the first indication towards the first wireless device 131. The first indication is configured to indicate the start of the training phase. The first network node 111 is also configured to, e.g. by means of a obtaining unit 902, configured to obtain directly or indirectly, based on the first indication configured to be sent, the set of information from the first wireless device 131, configured to indicate: i) the Doppler shift configured to be experienced by the first wireless device 131 while moving along the pre-defined trajectory 140 to which the static set of radio network nodes 120 are configured to provide radio coverage, and ii) the set of features configured to characterize how the first wireless device 131 is configured to experience the Doppler shift.

In some embodiments, the first network node 111 is configured to, e.g. by means of an initiating unit 903 within the first network node 111, configured to, initiate determining, using machine-learning, and based on the set of information configured to be received, the predictive model of Doppler shift pre-compensation. The training phase is configured to be of the predictive model.

In some embodiments, the set of features may be configured to comprise at least one of: a) the one or more uplink signals configured to be transmitted by the first wireless device 131 to indicate the Doppler shift configured to be experienced by the first wireless device 131, b) the velocity of the first wireless device 131 during the estimation of the Doppler shift, c) the direction of movement of the first wireless device 131 during the estimation of the Doppler shift, d) the measurement of the quality of the channel with at least one of the radio network nodes in the set of radio network nodes 120, and e) the one or more beams configured to be used by the first wireless device 131 to receive the one or more downlink signals for which the Doppler shift was configured to be experienced.

In some embodiments, wherein the obtaining of the set of information may be configured to be performed with the periodicity, the first network node 111 may be further configured to, e.g. by means of the sending unit 901 within the first network node 111, configured to, send the second indication towards the first wireless device 131. The second indication may be configured to indicate the change in the periodicity with which the first wireless device 131 may be to send the set of information.

In some embodiments, the first network node 111 may be further configured to, e.g. by means of the sending unit 901 within the first network node 111, configured to, send the another indication towards the first wireless device 131. The another indication may be configured to indicate that the training phase is to stop.

In some embodiments, wherein the first network node 111 may be configured to be one of the radio network nodes 120, and the predictive model configured to be determined may be configured to be the respective local model, the first network node 111 may be further configured to, e.g. by means of the sending unit 901 within the first network node 111, configured to, send the third indication to the another network node 113 configured to operate in the wireless communications network 100. The third indication may be configured to indicate the respective local model.

In some embodiments, wherein the first network node 111 may be configured to be one of the radio network nodes 120, and the predictive model configured to be determined may be configured to be the respective local model, the first network node 111 may be further configured to, e.g. by means of a receiving unit 904 within the first network node 111, configured to, receive the fourth indication from the another network node 113. The fourth indication may be configured to indicate that the respective local model of the predictive model of Doppler shift pre-compensation may be to be updated based on the global model configured to be determined by the another network node 113.

In some embodiments, wherein the first network node 111 may be configured to be one of the radio network nodes 120, and the predictive model configured to be determined may be configured to be the respective local model, the first network node 111 may be further configured to, e.g. by means of an updating unit 905 within the first network node 111, configured to, update the respective local model of the predictive model of Doppler shift pre-compensation based on the fourth indication configured to be received.

In some embodiments, the sending of the first indication may be configured to be performed after receiving the first indication from the another network node 113.

In some embodiments, the sending of the second indication may be configured to be performed after receiving the second indication from the another network node 113.

In some embodiments, the sending of the another indication may be configured to be performed after receiving the another indication from the another network node 113

In some embodiments, the first network node 111 may be configured to, e.g. by means of a determining unit 906 within the first network node 111, configured to, determine the Doppler shift pre-compensation value for the first wireless device 131 or the second wireless device 132. The determining of the Doppler shift pre-compensation value may be configured to be based on the respective local predictive model configured to be updated.

In some embodiments, the first network node 111 may be configured to, e.g. by means of an applying unit 907 within the first network node 111, configured to, apply the Doppler shift pre-compensation value configured to be determined in the first downlink transmission to the first wireless device 131 or the another wireless device 132.

In some embodiments, wherein the first network node 111 may be configured to be different from any of the radio network nodes 120, and wherein the obtaining may be further configured to comprise receiving the respective local model of the predictive model of Doppler shift pre-compensation configured to be determined by at least one of the radio network nodes 120, and wherein the predictive model configured to be determined may be a global model, the first network node 111 may be configured to, e.g. by means of the sending unit 901 within the first network node 111, configured to, send the fourth indication towards at least one of the radio network nodes 120. The fourth indication may be configured to indicate that the respective local model of the predictive model of Doppler shift pre-compensation may be to be updated based on the global model.

In some embodiments, the sending of the first indication may be configured to be performed via the at least one of the radio network nodes 120.

In some embodiments, the sending of the second indication may be configured to be performed via the at least one of the radio network nodes 120.

In some embodiments, the sending of the another indication may be configured to be performed via the at least one of the radio network nodes 120.

The embodiments herein in the first network node 111 may be implemented through one or more processors, such as a processor 908 in the first network node 111 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 909 comprising one or more memory units. The memory 909 is arranged to be used to store obtained information, store data, configurations, schedulings, and applications etc. to perform the methods herein when being executed in the first network node 111.

In some embodiments, the first network node 111 may receive information from, e.g., the second network node 112, the another network node 113, any of the radio network nodes in the set of radio network nodes 120, the first wireless device 131, and/or the second wireless device 132, through a receiving port 910. In some embodiments, the receiving port 910 may be, for example, connected to one or more antennas in first network node 111. In other embodiments, the first network node 111 may receive information from another structure in the wireless communications network 100 through the receiving port 910. Since the receiving port 910 may be in communication with the processor 908, the receiving port 910 may then send the received information to the processor 908. The receiving port 910 may also be configured to receive other information.

The processor 908 in the first network node 111 may be further configured to transmit or send information to e.g., the second network node 112, the another network node 113, any of the radio network nodes in the set of radio network nodes 120, the first wireless device 131, the second wireless device 132, and/or another structure in the wireless communications network 100, through a sending port 911, which may be in communication with the processor 908, and the memory 909.

Those skilled in the art will also appreciate that the different units 901-907 described above may refer to a combination of analog and digital modules, and/or one or more processors configured with software and/or firmware, e.g., stored in memory, that, when executed by the one or more processors such as the processor 908, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-907 described above may be implemented as one or more applications running on one or more processors such as the processor 908.

Thus, the methods according to the embodiments described herein for the first network node 111 may be respectively implemented by means of a computer program 912 product, comprising instructions, i.e., software code portions, which, when executed on at least one processor 908, cause the at least one processor 908 to carry out the actions described herein, as performed by the first network node 111. The computer program 912 product may be stored on a computer-readable storage medium 913. The computer-readable storage medium 913, having stored thereon the computer program 912, may comprise instructions which, when executed on at least one processor 908, cause the at least one processor 908 to carry out the actions described herein, as performed by the first network node 111. In some embodiments, the computer-readable storage medium 913 may be a non-transitory computer-readable storage medium, such as a CD ROM disc, or a memory stick. In other embodiments, the computer program 912 product may be stored on a carrier containing the computer program 912 just described, wherein the carrier is one of an electronic signal, optical signal, radio signal, or the computer-readable storage medium 913, as described above.

The first network node 111 may comprise a communication interface configured to facilitate communications between the first network node 111 and other nodes or devices, e.g., the second network node 112, the another network node 113, any of the radio network nodes in the set of radio network nodes 120, the first wireless device 131, the second wireless device 132 and/or another structure in the wireless communications network 100. The interface may, for example, include a transceiver configured to transmit and receive radio signals over an air interface in accordance with a suitable standard.

In other embodiments, the first network node 111 may comprise the following arrangement depicted in FIG. 9b. The first network node 111 may comprise a processing circuitry 908, e.g., one or more processors such as the processor 908, in the first network node 111 and the memory 909. The first network node 111 may also comprise a radio circuitry 914, which may comprise e.g., the receiving port 910 and the sending port 911. The processing circuitry 914 may be configured to, or operable to, perform the method actions according to FIG. 4, FIG. 7 and/or FIG. 8, in a similar manner as that described in relation to FIG. 9a.

The radio circuitry 914 may be configured to set up and maintain at least a wireless connection with the second network node 112, the another network node 113, any of the radio network nodes in the set of radio network nodes 120, the first wireless device 131, the second wireless device 132 and/or another structure in the wireless communications network 100. Circuitry may be understood herein as a hardware component.

Hence, embodiments herein also relate to the first network node 111 comprising the processing circuitry 908 and the memory 909, said memory 909 containing instructions executable by said processing circuitry 908, whereby the first network node 111 is operative to perform the actions described herein in relation to the first network node 111, e.g., in Figure FIG. 4, FIG. 7 and/or FIG. 8.

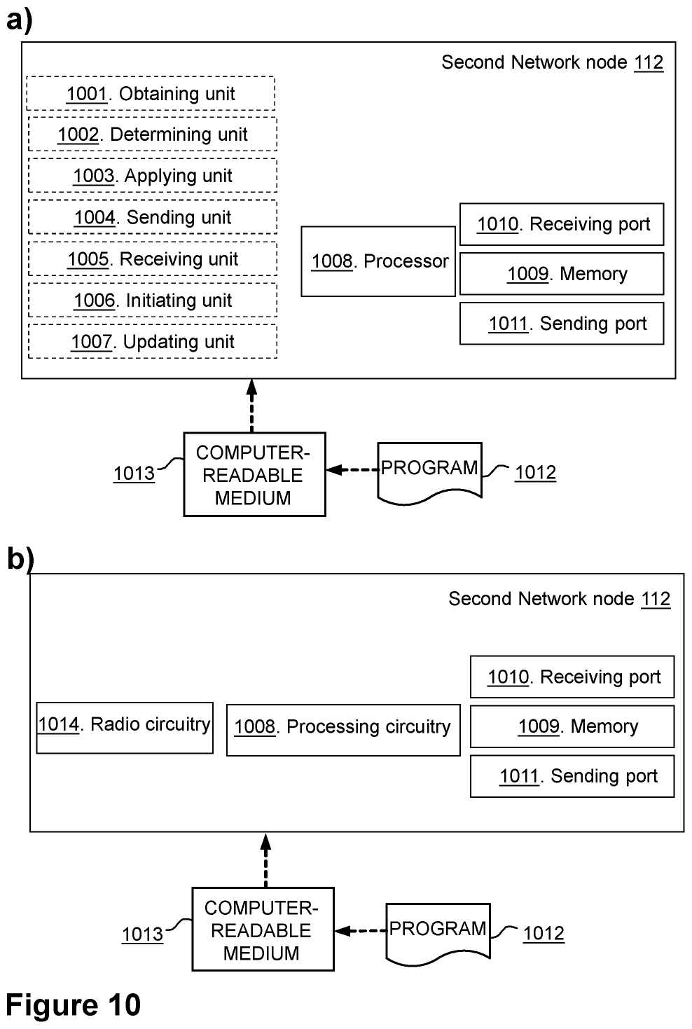

FIG. 10 depicts two different examples in panels a) and b), respectively, of the arrangement that the second network node 112 may comprise to perform the method actions described above in relation to FIG. 4. In some embodiments, the second network node 112 may comprise the following arrangement depicted in FIG. 10a. The second network node 112 may be understood to be for handling Doppler shift pre-compensation. The second network node 112 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second network node 112 and will thus not be repeated here. For example, the wireless device 131, 132 may be configured to be located in the high speed train.

In FIG. 10, optional units are indicated with dashed boxes.

The second network node 112 is configured to, e.g. by means of an obtaining unit 1001 within the second network node 112, configured to obtain the sixth indication of the Doppler shift configured to be experienced by the wireless device 131, 132 while moving along the pre-defined trajectory 140 to which the static set of radio network nodes 120 are configured to provide radio coverage.

The second network node 112 is also configured to, e.g. by means of a determining unit 1002, configured to determine, based on the sixth indication configured to be obtained and after having obtained the sixth indication only once, the Doppler shift pre-compensation value. The determining may be configured to be based on the predictive model. The predictive model may be configured to have been determined using machine learning based at least on the trajectory 140 and the static set of radio network nodes 112, 113 configured to be serving the trajectory 140.

The second network node 112 is also configured to, e.g. by means of an applying unit 1003, configured to apply the Doppler shift pre-compensation value configured to be determined to the second downlink transmission to the wireless device 131, 132, in response to the sixth indication configured to be obtained.

In some embodiments, the second network node 112 may be configured to, e.g. by means of a sending unit 1004 within the second network node 112, configured to, send the fifth indication towards the first wireless device 131. The fifth indication may be configured to indicate the start of the execution phase of the predictive model of Doppler shift pre-compensation. The obtaining of the sixth indication may be configured to be triggered by the fifth indication configured to be sent.

In some embodiments, the second network node 112 may be configured to, e.g. by means of a receiving unit 1005 within the second network node 112, configured to, receive the fifth indication from the first network node 111 configured to operate in the wireless communications network 100. The sending of the fifth indication may be configured to be triggered by the fifth indication configured to be obtained.

In some embodiments, the second network node 112 may be configured to, e.g. by means of the receiving unit 1005 within the second network node 112, configured to, receive the first indication from the first network node 111 configured to operate in the wireless communications network 100. The first indication may be configured to indicate the start of the training phase of the predictive model of the Doppler shift pre-compensation.

In some embodiments, the second network node 112 may be configured to, e.g. by means of the sending unit 1004 within the second network node 112, configured to, send the first indication towards the first wireless device 131.

In some embodiments, the second network node 112 may be configured to, e.g. by means of the obtaining unit 1001 within the second network node 112, configured to, obtain, directly or indirectly, based on the first indication configured to be sent, the set of information from the first wireless device 131, configured to indicate: i) the Doppler shift configured to be experienced by the first wireless device 131 while moving along the pre-defined trajectory 140 to which the static set of radio network nodes 120 may be configured to provide the radio coverage, and ii) the set of features configured to characterize how the first wireless device 131 may be configured to have experienced the Doppler shift.

In some embodiments, the second network node 112 may be configured to, e.g. by means of an initiating unit 1006 within the second network node 112, configured to, initiate determining, using machine-learning, and based on the set of information configured to be received, the predictive model of Doppler shift pre-compensation.

In some embodiments, the set of features may be configured to comprise at least one of: a) the one or more uplink signals configured to be transmitted by the first wireless device 131 to indicate the Doppler shift configured to be experienced by the first wireless device 131, b) the velocity of the first wireless device 131 during the estimation of the Doppler shift, c) the direction of movement of the first wireless device 131 during the estimation of the Doppler shift, d) the measurement of the quality of the channel with at least one of the radio network nodes in the set of radio network nodes 120, and e) the one or more beams configured to be used by the first wireless device 131 to receive the one or more downlink signals for which the Doppler shift was configured to be experienced.

In some embodiments, wherein the obtaining of the set of information may be configured to be performed with the periodicity, the second network node 112 may be further configured to, e.g. by means of the receiving unit 1005 within the second network node 112, configured to, receive the second indication from the first network node 111. The second indication may be configured to indicate the change in the periodicity with which the first wireless device 131 may be to send the set of information.

In some embodiments, wherein the obtaining of the set of information may be configured to be performed with the periodicity, the second network node 112 may be further configured to, e.g. by means of the sending unit 1004 within the second network node 112, configured to, send the second indication towards the first wireless device 131.

In some embodiments, the second network node 112 may be further configured to, e.g. by means of the receiving unit 1005 within the second network node 112, configured to, receive the another indication from the first network node 111. The another indication may be configured to indicate that the training phase is to stop.

In some embodiments, the second network node 112 may be further configured to, e.g. by means of the sending unit 1004 within the second network node 112, configured to, send the another indication towards the first wireless device 131.

In some embodiments, wherein the second network node 112 may be configured to be one of the radio network nodes 120, and the predictive model configured to be determined may be configured to be the respective local model, the second network node 112 may be further configured to, e.g. by means of the sending unit 1004 within the second network node 112, configured to, send the third indication to the another network node 113 configured to operate in the wireless communications network 100. The third indication may be configured to indicate the respective local model.

In some embodiments, wherein the second network node 112 may be configured to be one of the radio network nodes 120, and the predictive model configured to be determined may be configured to be the respective local model, the second network node 112 may be further configured to, e.g. by means of the receiving unit 1005 within the second network node 112, configured to, receive the fourth indication from the another network node 113. The fourth indication may be configured to indicate that the respective local model of the predictive model of Doppler shift pre-compensation may be to be updated based on the global model configured to be determined by the another network node 113.

In some embodiments, wherein the second network node 112 may be configured to be one of the radio network nodes 120, and the predictive model configured to be determined may be configured to be the respective local model, the second network node 112 may be further configured to, e.g. by means of an updating unit 1007 within the second network node 112, configured to, update the respective local model of the predictive model of Doppler shift pre-compensation based on the fourth indication configured to be received.

The embodiments herein in the second network node 112 may be implemented through one or more processors, such as a processor 1008 in the second network node 112 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The second network node 112 may further comprise a memory 1009 comprising one or more memory units. The memory 1009 is arranged to be used to store obtained information, store data, configurations, schedulings, and applications etc. to perform the methods herein when being executed in the second network node 112.

In some embodiments, the second network node 112 may receive information from, e.g., the first network node 111, the another network node 113, any of the radio network nodes in the set of radio network nodes 120, the first wireless device 131, and/or the second wireless device 132, through a receiving port 1010. In some embodiments, the receiving port 1010 may be, for example, connected to one or more antennas in second network node 112. In other embodiments, the second network node 112 may receive information from another structure in the wireless communications network 100 through the receiving port 1010. Since the receiving port 1010 may be in communication with the processor 1008, the receiving port 1010 may then send the received information to the processor 1008. The receiving port 1010 may also be configured to receive other information.

The processor 1008 in the second network node 112 may be further configured to transmit or send information to e.g., the first network node 111, the another network node 113, any of the radio network nodes in the set of radio network nodes 120, the first wireless device 131, the second wireless device 132, and/or another structure in the wireless communications network 100, through a sending port 1011, which may be in communication with the processor 1008, and the memory 1009.

Those skilled in the art will also appreciate that the different units 1001-1007 described above may refer to a combination of analog and digital modules, and/or one or more processors configured with software and/or firmware, e.g., stored in memory, that, when executed by the one or more processors such as the processor 1008, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1001-1007 described above may be implemented as one or more applications running on one or more processors such as the processor 1008.

Thus, the methods according to the embodiments described herein for the second network node 112 may be respectively implemented by means of a computer program 1012 product, comprising instructions, i.e., software code portions, which, when executed on at least one processor 1008, cause the at least one processor 1008 to carry out the actions described herein, as performed by the second network node 112. The computer program 1012 product may be stored on a computer-readable storage medium 1013. The computer-readable storage medium 1013, having stored thereon the computer program 1012, may comprise instructions which, when executed on at least one processor 1008, cause the at least one processor 1008 to carry out the actions described herein, as performed by the second network node 112. In some embodiments, the computer-readable storage medium 1013 may be a non-transitory computer-readable storage medium, such as a CD ROM disc, or a memory stick. In other embodiments, the computer program 1012 product may be stored on a carrier containing the computer program 1012 just described, wherein the carrier is one of an electronic signal, optical signal, radio signal, or the computer-readable storage medium 1013, as described above.

The second network node 112 may comprise a communication interface configured to facilitate communications between the second network node 112 and other nodes or devices, e.g., the first network node 111, the another network node 113, any of the radio network nodes in the set of radio network nodes 120, the first wireless device 131, the second wireless device 132, and/or another structure in the wireless communications network 100. The interface may, for example, include a transceiver configured to transmit and receive radio signals over an air interface in accordance with a suitable standard.

In other embodiments, the second network node 112 may comprise the following arrangement depicted in FIG. 10b. The second network node 112 may comprise a processing circuitry 1008, e.g., one or more processors such as the processor 1008, in the second network node 112 and the memory 1009. The second network node 112 may also comprise a radio circuitry 1014, which may comprise e.g., the receiving port 1010 and the sending port 1011. The processing circuitry 1014 may be configured to, or operable to, perform the method actions according to FIG. 5, FIG. 7 and/or FIG. 8, in a similar manner as that described in relation to FIG. 10a. The radio circuitry 1014 may be configured to set up and maintain at least a wireless connection with the first network node 111, the another network node 113, any of the radio network nodes in the set of radio network nodes 120, the first wireless device 131, the second wireless device 132, and/or another structure in the wireless communications network 100. Circuitry may be understood herein as a hardware component. Hence, embodiments herein also relate to the second network node 112 comprising the processing circuitry 1008 and the memory 1009, said memory 1009 containing instructions executable by said processing circuitry 1008, whereby the second network node 112 is operative to perform the actions described herein in relation to the second network node 112, e.g., in FIG. 5, FIG. 7 and/or FIG. 8.

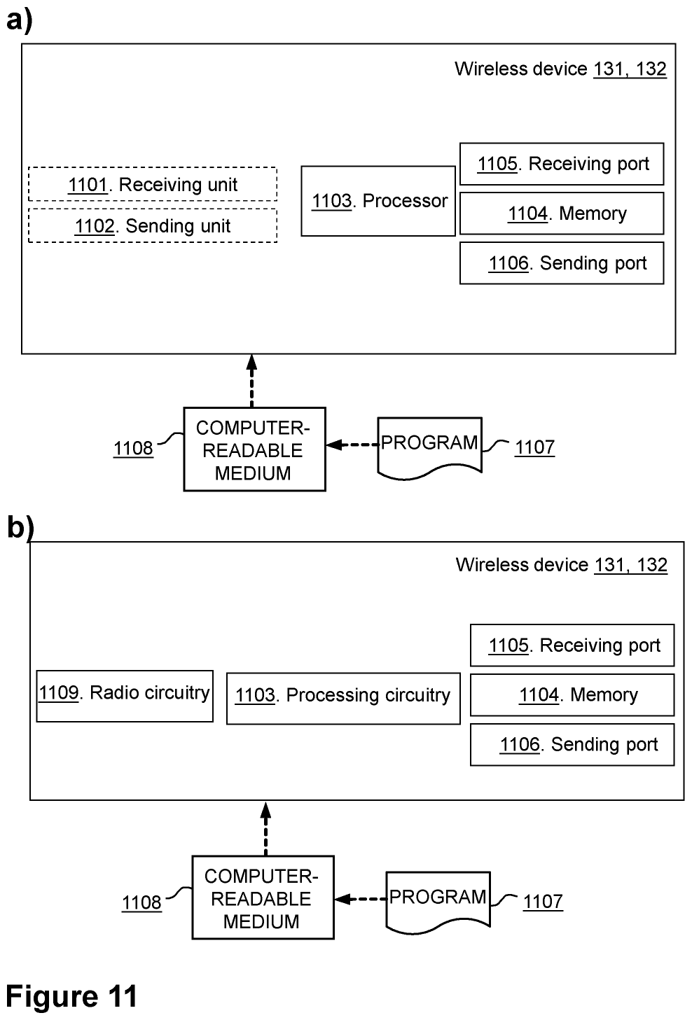

FIG. 11 depicts two different examples in panels a) and b), respectively, of the arrangement that the wireless device 131, 132 may comprise to perform the method actions described above in relation to FIG. 6. In some embodiments, the wireless device 131, 132 may comprise the following arrangement depicted in FIG. 11a. The wireless device 131, 132 may be understood to be for handling Doppler shift pre-compensation. The wireless device 131, 132 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first wireless device 131 and the wireless device 131, 132, and will thus not be repeated here. For example, the wireless device 131, 132 may be configured to be located in the high speed train.

In FIG. 11, optional units are indicated with dashed boxes.

The wireless device 131, 132 is configured to, e.g. by means of a receiving unit 1101 within the wireless device 131, 132, configured to, receive the first indication from the first network node 111 configured to operate in the wireless communications network 100. The first indication is configured to indicate the start of the training phase of the predictive model of Doppler shift pre-compensation.

The wireless device 131, 132 is configured to, e.g. by means of a sending unit 1102 within the wireless device 131, 132, configured send towards the first network node 111, based on the first indication configured to be received, the set of information from the wireless device 131, 132, configured to indicate: i) the Doppler shift configured to be experienced by the wireless device 131, 132 while moving along the pre-defined trajectory 140 to which the static set of radio network nodes 120 are configured to provide radio coverage, and ii) the set of features configured to characterize how the wireless device 131, 132 is configured to have experienced the Doppler shift.

In some embodiments, the wireless device 131, 132 may be configured to, e.g. by means of the receiving unit 1101 configured to, receive the first downlink transmission from the first network node 111. The first downlink transmission is configured to be based on the set of information configured to be sent.

In some embodiments, the set of features may be configured to comprise at least one of: a) the one or more uplink signals configured to be transmitted by the first wireless device 131 to indicate the Doppler shift configured to be experienced by the wireless device 131, 132, b) the velocity of the wireless device 131, 132 during the estimation of the Doppler shift, c) the direction of movement of the wireless device 131, 132 during the estimation of the Doppler shift, d) the measurement of the quality of the channel with at least one of the radio network nodes in the set of radio network nodes 120, and e) the one or more beams configured to be used by the wireless device 131, 132 to receive the one or more downlink signals for which the Doppler shift was configured to be experienced.

In some embodiments, wherein the obtaining of the set of information may be configured to be performed with the periodicity, the wireless device 131, 132 may be further configured to, e.g. by means of the receiving unit 1101 within the wireless device 131, 132, configured to, receive the second indication from the first network node 111. The second indication may be configured to indicate the change in the periodicity with which the wireless device 131, 132 may be to send the set of information.

In some embodiments, the wireless device 131, 132 may be further configured to, e.g. by means of the receiving unit 1101 within the second network node 112, configured to, receive the another indication from the first network node 111. The another indication may be configured to indicate that the training phase is to stop.

In some embodiments, the wireless device 131, 132 may be further configured to, e.g. by means of the receiving unit 1101 within the second network node 112, configured to, receive the fifth indication from the second network node 112 configured to operate in the wireless communications network 100. The fifth indication may be configured to indicate the start of the execution phase of the predictive model of Doppler shift pre-compensation.

The wireless device 131, 132 is configured to, e.g. by means of the sending unit 1102 within the wireless device 131, 132, configured send, to the second network node 112, the sixth indication of the Doppler shift configured to be experienced by the wireless device 131, 132 while moving along the pre-defined trajectory 140. The sending of the sixth indication may be configured to be triggered by the fifth indication configured to be received.

In some embodiments, the wireless device 131, 132 may be further configured to, e.g. by means of the receiving unit 1101 within the second network node 112, configured to, receive the second downlink transmission from the second network node 112. The second downlink transmission may be configured to be based on the sixth indication configured to be sent.

The embodiments herein in the wireless device 131, 132 may be implemented through one or more processors, such as a processor 1103 in the wireless device 131, 132 depicted in FIG. 11a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 131, 132. One such carrier may be in the form of a CD ROM disc. It is however feasible with other data carriers such as a memory stick. The computer program code may furthermore be provided as pure program code on a server and downloaded to the wireless device 131, 132.

The wireless device 131, 132 may further comprise a memory 1104 comprising one or more memory units. The memory 1104 is arranged to be used to store obtained information, store data, configurations, schedulings, and applications etc. to perform the methods herein when being executed in the wireless device 131, 132.

In some embodiments, the wireless device 131, 132 may receive information from, e.g., the first network node 111, the second network node 112, the another network node 113, any of the radio network nodes in the set of radio network nodes 120, the first wireless device 131, and/or the second wireless device 132, through a receiving port 1105. In some embodiments, the receiving port 1105 may be, for example, connected to one or more antennas in wireless device 131, 132. In other embodiments, the wireless device 131, 132 may receive information from another structure in the wireless communications network 100 through the receiving port 1105. Since the receiving port 1105 may be in communication with the processor 1103, the receiving port 1105 may then send the received information to the processor 1103. The receiving port 1105 may also be configured to receive other information.

The processor 1103 in the wireless device 131, 132 may be further configured to transmit or send information to e.g., the first network node 111, the second network node 112, the another network node 113, any of the radio network nodes in the set of radio network nodes 120, the first wireless device 131, the second wireless device 132, and/or another structure in the wireless communications network 100, through a sending port 1106, which may be in communication with the processor 1103, and the memory 1104.

Those skilled in the art will also appreciate that the different units 1101-1102 described above may refer to a combination of analog and digital modules, and/or one or more processors configured with software and/or firmware, e.g., stored in memory, that, when executed by the one or more processors such as the processor 1103, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1101-1102 described above may be implemented as one or more applications running on one or more processors such as the processor 1103.

Thus, the methods according to the embodiments described herein for the wireless device 131, 132 may be respectively implemented by means of a computer program 1107 product, comprising instructions, i.e., software code portions, which, when executed on at least one processor 1103, cause the at least one processor 1103 to carry out the actions described herein, as performed by the wireless device 131, 132. The computer program 1107 product may be stored on a computer-readable storage medium 1108. The computer-readable storage medium 1108, having stored thereon the computer program 1107, may comprise instructions which, when executed on at least one processor 1103, cause the at least one processor 1103 to carry out the actions described herein, as performed by the wireless device 131, 132. In some embodiments, the computer-readable storage medium 1108 may be a non-transitory computer-readable storage medium, such as a CD ROM disc, or a memory stick. In other embodiments, the computer program 1107 product may be stored on a carrier containing the computer program 1107 just described, wherein the carrier is one of an electronic signal, optical signal, radio signal, or the computer-readable storage medium 1108, as described above.

The wireless device 131, 132 may comprise a communication interface configured to facilitate communications between the wireless device 131, 132 and other nodes or devices, e.g., the first network node 111, the second network node 112, the another network node 113, any of the radio network nodes in the set of radio network nodes 120, the first wireless device 131, the second wireless device 132, and/or another structure in the wireless communications network 100. The interface may, for example, include a transceiver configured to transmit and receive radio signals over an air interface in accordance with a suitable standard.

In other embodiments, the wireless device 131, 132 may comprise the following arrangement depicted in FIG. 11b. The wireless device 131, 132 may comprise a processing circuitry 1103, e.g., one or more processors such as the processor 1103, in the wireless device 131, 132 and the memory 1104. The wireless device 131, 132 may also comprise a radio circuitry 1109, which may comprise e.g., the receiving port 1105 and the sending port 1106. The processing circuitry 1103 may be configured to, or operable to, perform the method actions according to FIG. 6, FIG. 7 and/or FIG. 8, in a similar manner as that described in relation to FIG. 11a. The radio circuitry 1109 may be configured to set up and maintain at least a wireless connection with the first network node 111, the second network node 112, the another network node 113, any of the radio network nodes in the set of radio network nodes 120, the first wireless device 131, the second wireless device 132, and/or another structure in the wireless communications network 100. Circuitry may be understood herein as a hardware component.

Hence, embodiments herein also relate to the wireless device 131, 132 comprising the processing circuitry 1103 and the memory 1104, said memory 1104 containing instructions executable by said processing circuitry 1103, whereby the wireless device 131, 132 is operative to perform the actions described herein in relation to the wireless device 131, 132, e.g., in FIG. 6, FIG. 7 and/or FIG. 8.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of: ” followed by a list of alternatives separated by commas, and wherein the last alternative is preceded by the “or” term.

### REFERENCES

1. RP-193133, “New WID: Further enhancements on MIMO for NR”, 3GPP TSG RAN Meeting #86, Sitges, Spain, Dec. 9-12, 2019.
2. 3GPP R1-2007383, “Session notes for 8.1 (Further enhancements on MIMO for NR)”, Samsung, RAN1 #102-e, August 2020.
3. 3GPP R1-2100067, “Enhancements for M-TRP Transmission to Support HST-SFN in Rel-17”, InterDigital, Inc., RAN1 #104-e, February 2021.
4. 3GPP R1-2100122, “Enhancements on HST-SFN deployment”, OPPO, RAN1 #104-e, February 2021. 3GPP R1-2100347, “Discussion on enhancements for HST-SFN deployment”, CATT, RAN1 #104-e, February 2021.
5. 3GPP R1-2101009, “Enhancements for HST-SFN deployment”, Nokia, Nokia Shanghai Bell, RAN1 #104-e, February 2021.
6. 3GPP R1-2101036, “Enhancements on HST-SFN deployment”, CMCC, RAN1 #104-e, February 2021.
7. Shuangfeng Han, Chih-Lin I, Tian Xie, Sen Wang, Yuhong Huang, Linglong Dai, Qi Sun, and Chunfeng Cui, “Achieving High Spectrum Efficiency on High Speed Train for 5G New Radio and Beyond”, in IEEE Wireless Communications, vol. 26, no. 5, pp. 62-69, October 2019.
8. N. Jamaly, S. Mauron, R. Merz, A. Schumacher and D. Wenger, “Delivering Gigabit Capacities to Passenger Trains: Tales from an Operator on the Road to 5G,” in IEEE Communications Magazine, vol. 57, no. 9, pp. 18-23, September 2019.
9. Xiong, Lei, Zhengyu Zhang, and Dongpin Yao. “Dynamic Doppler prediction in high-speed rail using long short-term memory neural network.” Transactions on Emerging Telecommunications Technologies (2021): e4269.

1. A method, performed by a first network node, the method being for handling Doppler shift pre-compensation, the first network node operating in a wireless communications network, the method comprising:
sending a first indication towards a first wireless device, the first indication indicating a start of a training phase;
obtaining directly or indirectly, based on the sent first indication, a set of information from the first wireless device, indicating:
i. a Doppler shift experienced by the first wireless device while moving along a pre-defined trajectory to which a static set of radio network nodes provide radio coverage; and
ii. a set of features characterizing how the first wireless device experienced the Doppler shift, and;
initiating determining, using machine-learning, and based on the received set of information, a predictive model of Doppler shift pre-compensation, the training phase is of the predictive model, the first network node being one of the radio network nodes, the determined predictive model being a respective local model;
sending a third indication to another network node operating in the wireless communications network, the third indication indicating the respective local model,
receiving a fourth indication from the another network node, the fourth indication indicating that the respective local model of the predictive model of Doppler shift pre-compensation is to be updated based on a global model determined by the another network node;
updating the respective local model of the predictive model of Doppler shift pre-compensation based on the received fourth indication;
determining a Doppler shift pre-compensation value for the first wireless device or a second wireless device, the determining of the Doppler shift pre-compensation value being based on the updated respective local predictive model; and
applying the determined Doppler shift pre-compensation value in a first downlink transmission to the first wireless device or the another wireless device.

2. The method according to claim 1, wherein the set of features comprises at least one of:
a. one or more uplink signals transmitted by the first wireless device to indicate the Doppler shift experienced by the first wireless device;
b. a velocity of the first wireless device during the estimation of the Doppler shift;
c. a direction of movement of the first wireless device during the estimation of the Doppler shift;
d. a measurement of a quality of a channel with at least one of the radio network nodes in the set of radio network nodes; and
e. one or more beams used by the first wireless device to receive one or more downlink signals for which the Doppler shift was experienced.

3. The method according to claim 1, wherein the obtaining of the set of information is performed with a periodicity, and wherein the method further comprises:
sending a second indication towards the first wireless device, the second indication indicating a change in the periodicity with which the first wireless device is to send the set of information.

4. The method according to claim 1, the method further comprising:
sending another indication towards the first wireless device, the another indication indicating that the training phase is to stop.

5. (canceled)

6. The method according to claim 1, wherein the sending of the first indication is performed after receiving the first indication from the another network node.

7. The method according to claim 3, wherein the sending of the second indication is performed after receiving the second indication from the another network node.

8. The method according to claim 4, wherein the sending of the another indication is performed after receiving the another indication from the another network node.

9. (canceled)

10. The method according to claim 1, wherein the first network node is different from any of the radio network nodes, wherein the obtaining further comprises receiving a respective local model of the predictive model of Doppler shift pre-compensation determined by at least one of the radio network nodes, wherein the determined predictive model is a global model, and wherein the method further comprises:
sending a fourth indication towards at least one of the radio network nodes, the fourth indication indicating that the respective local model of the predictive model of Doppler shift pre-compensation is to be updated based on the global model.

11. The method according to claim 10, wherein the sending of the first indication is performed via the at least one of the radio network nodes.

12. The method according to claim 3, wherein the sending of the second indication is performed via the at least one of the radio network nodes.

13. The method according to claim 4, wherein the sending of the another indication is performed via the at least one of the radio network nodes.

14. The method according to claim 1, wherein the first wireless device is located in a high speed train.

15.-23. (canceled)

24. A method, performed by a wireless device, the method being for handling Doppler shift pre-compensation, the wireless device operating in a wireless communications network, the method comprising:
receiving a first indication from a first network node operating in the wireless communications network, the first indication indicating a start of a training phase of a predictive model of Doppler shift pre-compensation;
sending towards the first network node, based on the received first indication, a set of information from the wireless device, indicating:
i. a Doppler shift experienced by the wireless device while moving along a pre-defined trajectory to which a static set of radio network nodes (120) provide radio coverage; and
ii. a set of features characterizing how the wireless device experienced the Doppler shift;
receiving a first downlink transmission from the first network node, the first downlink transmission being based on the sent set of information, receiving the first downlink transmission comprising a pre-compensated PDCCH and PDSCH from the one or more of the set of radio network nodes.

25. The method according to claim 24, wherein the set of features comprises at least one of:
a. one or more uplink signals transmitted by the wireless device to indicate the Doppler shift experienced by the wireless device;
b. a velocity of the wireless device during the estimation of the Doppler shift;
c. a direction of movement of the wireless device during the estimation of the Doppler shift;
d. a measurement of a quality of a channel with at least one of the radio network nodes in the set of radio network nodes; and
e. one or more beams used by the wireless device to receive one or more downlink signals for which the Doppler shift was experienced.

26. The method according to claim 24, wherein the obtaining of the set of information is performed with a periodicity, and wherein the method further comprises:
receiving a second indication from the first network node, the second indication indicating a change in the periodicity with which the wireless device is to send the set of information.

27. The method according to claim 24, the method further comprising:
receiving another indication from the first network node, the another indication indicating that the training phase is to stop.

28. The method according to claim 24, further comprising:
receiving a fifth indication from a second network node operating in the wireless communications network, the fifth indication indicating a start of an execution phase of the predictive model of Doppler shift pre-compensation;
sending, to the second network node, a sixth indication of a Doppler shift experienced by the wireless device while moving along the pre-defined trajectory, wherein the sending of the sixth indication is triggered by the received fifth indication; and
receiving a second downlink transmission from the second network node, second downlink transmission being based on the sent sixth indication.

29. The method according to claim 24, wherein the first wireless device is located in a high speed train.

30. A first network node, for handling Doppler shift pre-compensation, the first network node being configured to operate in a wireless communications network, the first network node being further configured to:
send a first indication towards a first wireless device, the first indication being configured to indicate a start of a training phase;
obtain directly or indirectly, based on the first indication configured to be sent, a set of information from the first wireless device, configured to indicate:
i. a Doppler shift configured to be experienced by the first wireless device while moving along a pre-defined trajectory to which a static set of radio network nodes are configured to provide radio coverage; and
ii. a set of features configured to characterize how the first wireless device is configured to experience the Doppler shift, and;
initiate determining, using machine-learning, and based on the set of information configured to be received, a predictive model of Doppler shift pre-compensation, wherein the training phase is configured to be of the predictive model, the first network node being configured to be one of the radio network nodes, the predictive model configured to be determined being configured to be a respective local model;
send a third indication to another network node configured to operate in the wireless communications network, the third indication being configured to indicate the respective local model;
receive a fourth indication from the another network node, the fourth indication being configured to indicate that the respective local model of the predictive model of Doppler shift pre-compensation is to be updated based on a global model configured to be determined by the another network node;
update the respective local model of the predictive model of Doppler shift pre-compensation based on the fourth indication configured to be received;
determine a Doppler shift pre-compensation value for the first wireless device or a second wireless device, the determining of the Doppler shift pre-compensation value being configured to be based on the respective local predictive model configured to be updated; and
apply the Doppler shift pre-compensation value configured to be determined in a first downlink transmission to the first wireless device or the another wireless device.

31.-52. (canceled)

53. A wireless device, for handling Doppler shift pre-compensation, the wireless device being configured to operate in a wireless communications network, the wireless device being further configured to:
receive a first indication from a first network node configured to operate in the wireless communications network, the first indication being configured to indicate a start of a training phase of a predictive model of Doppler shift pre-compensation;
send towards the first network node, based on the first indication configured to be received, a set of information from the wireless device , configured to indicate:
i. a Doppler shift configured to be experienced by the wireless device while moving along a pre-defined trajectory to which a static set of radio network nodes are configured to provide radio coverage; and
ii. a set of features configured to characterize how the wireless device is configured to have experienced the Doppler shift; and
receive a first downlink transmission from the first network node, the first downlink transmission being configured to be based on the set of information configured to be sent, receiving of the first downlink transmission comprising a pre-compensated PDCCH and PDSCH from the one or more of the set of radio network nodes.

54.-58. (canceled)
